(19) United States
(12) Patent Application Publication
(10) Pub. No.: US 2018/0189874 A1
(43) Pub. Date: Jul. 5, 2018

(54) SYSTEMS AND METHODS FOR BOND PRICING

(71) Applicant: JPMorgan Chase Bank, N.A., New York, NY (US)

(72) Inventors: Mark James Annett, Rye, NY (US); Rajesh Dinesh Kalyanpur, Green Brook, NJ (US); Ramana Krishna Kiran Duddagi, Edison, NJ (US)

(21) Appl. No.: 14/083,890

(22) Filed: Nov. 19, 2013

(51) Int. Cl. G06Q 40/04

(52) U.S. Cl. CPC G06Q 40/04

(57) ABSTRACT

The present invention may be mainly embodied in a Bond Pricing System (BPS), which is a web-based tool for creating and pricing new bond issues. According to one particular embodiment, the BPS may be a web-based system that is coded in Java and Oracle. In general, the BPS accepts user input of bond pricing parameters (terms), retrieves historical pricing and market comparables data for similar bonds, prices the proposed bond, and generates a properly formatted bond pricing sheet. The bond pricing sheet is sent electronically to the Syndicate desk so that, upon approval, it can be sent to the bond issuer. A number of additional features of the BPS are disclosed.

### CROSS-REFERENCE TO RELATED APPLICATION(S)

The present application is related to a co-pending, commonly-owned patent application of the same title, U.S. patent application Ser. No. ______, filed concurrently herewith (Ref. No. 72167.020252), which is incorporated herein by reference in its entirety.

### FIELD OF THE INVENTION

The present invention relates generally to financial processing and workflow management, and more particularly, to systems and methods for bond pricing including a software tool for creating and pricing new bond issues (and other securities or financial instruments).

### BACKGROUND OF THE INVENTION

In finance, a bond is a debt instrument typically issued by a corporation, municipality, or government (i.e., a bond issuer) to investors (i.e., bond buyers or bond holders). Based on the terms of the bond, the issuer owes the holders a debt and is typically obligated to pay them interest (coupon rate) and to repay the principal at a later date (maturity). Thus, the issuer is effectively a borrower or debtor and each bond holder is a lender or creditor. By issuing a bond, an issuing company can raise funds from investors to meet its needs for capital without sacrificing any equity stake in the company.

The most common process for issuing corporate bonds or municipal bonds is through underwriting where one or more firms (e.g., investment banks or securities dealers) form a syndicate that buys the entire issue of bonds from the issuer and re-sell them to investors. This syndicate arrangement spreads the risk of the new bond issue to a larger number of participating firms and also improves the likelihood of selling all of the newly issued bonds. One of the underwriter firms usually acts as bookrunner to handle the primary issuance, for example, by advising the bond issuer on timing and pricing, arranging the bond issue, and dealing with investors.

A critical step in the bond issuance process is pricing the new bond issue at an appropriate level. It is important not to set the price too high (to avoid a low demand) or too low (to reduce capital costs to the issuer). The syndicate also need to agree on the final pricing level so as to ensure adequate compensation for the risks they assume in underwriting the new issue. Bond pricing is typically done through the collaboration of the bookrunner and its syndicate partners. For example, the Debt Capital Markets (DCM) desk of the bookrunner (which is usually an investment bank) may be responsible for setting up a new bond issue before sending it to a Syndicate desk for pricing.

Previously, the DCM desk would manually conduct all comparable analysis related to bond pricing, for example, with spreadsheets. The DCM personnel would retrieve reference data by going to specific data sources and copying and pasting the data into a template. Next, a DCM user would run multiple functions and macros embedded in the spreadsheet to perform data analysis and ultimately arrive at the information needed for the Syndicate desk. Once this manual analysis is completed, the basic pricing terms (e.g., coupon yield, duration, etc.) and previous market data on similar bonds are manually aggregated into a package that is delivered to the Syndicate desk. The Syndicate desk will subsequently start working on the information package and prepare a bond pricing proposal (a.k.a. “pricing sheet”) to send to the issuing company.

This prior approach to bond pricing is inefficient in a number of aspects. First, there was no systematic approach to the collection, organization, and presentation of historical pricing data or market comparables data for purposes of bond pricing. The manual retrieval of reference data is both time-consuming and error-prone. Second, the collaboration between the DCM desk and the Syndicate desk lacked effective workflow control. A new pricing request could be queued for weeks without receiving proper attention. When only a week or less is allocated to the pricing of a new issue, even a couple days' delay could be unacceptable to the clients. Third, the generation, distribution, and storage of final pricing sheets and/or related information were not streamlined and lacked consistency. It was also difficult for all relevant parties to communicate about or collaborate on the pricing sheets or new issues in general. Furthermore, the previous bond pricing was usually limited to a single currency and it was cumbersome to access the resources needed for cross-currency pricing. In general, prior bond pricing approaches involved a significant amount of manual, repetitive operations which tend to limit their pricing capabilities.

Other problems and drawbacks also exist.

### SUMMARY OF THE INVENTION

Accordingly, it is one object of the present invention to overcome one or more of the aforementioned and other limitations of existing systems and methods for bond pricing by providing a bond pricing system which enables users to efficiently create indicative bond pricing sheets in a proper format.

It is another object of the invention to create significant time savings, primarily for investment banking analysts and/or associates, through the enhanced efficiency and capabilities of a bond pricing system, such as real-time market data and/or reference data, automated pricing sheet creation, and historical pricing data.

The present invention may be mainly embodied in a Bond Pricing System (BPS), which is a web-based tool for creating and pricing new bond issues. According to one particular embodiment, the BPS may be a web-based system that is coded in Java and Oracle. In general, the BPS accepts user input of bond pricing parameters (terms), retrieves historical pricing and market comparables data for similar bonds, prices the proposed bond, and generates a properly formatted bond pricing sheet. The bond pricing sheet (at this point, a proposal) is sent electronically to the Syndicate desk so that, upon approval, it can be sent to the bond issuer.

The present invention also allows bond pricing parameters to be adjusted for the benefit of clients (corporate issuers) and the underwriting bank(s). There may be multiple underwriting banks forming a Syndicate that purchases the bond issue from the company and resells the bonds to primary market buyers (typically, large institutional investors). Bonds may be traded on the secondary market by investors. Once issued, a bond's market price can vary based on prevailing interest rates, changed risk profile for the issuer, etc. BPS can be used for pricing various types of bonds, including investment grade bonds.

One technical effect of the invention is to provide systems and methods for bond pricing that allow automated generation of an electronic pricing sheet and efficient aggregation of related financial data.

Another technical effect of the invention is to facilitate efficient and effective collaboration among different users on the preparation, review, and revision of bond pricing.

Yet another technical effect of the invention is the centralized electronic control, organization, and tracking of bond pricing materials and related data.

The accompanying drawings are included to provide a further understanding of the invention and are incorporated in and constitute part of this specification, illustrate several embodiments of the invention and, together with the description, serve to explain the principles of the invention. Additional features and advantages of the invention will be set forth in the description that follows, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

The purpose and advantages of the present invention will be apparent to those of skill in the art from the following detailed description in conjunction with the appended drawings in which like reference characters are used to indicate like elements.

FIG. 1 is a flowchart illustrating an exemplary method for bond pricing according to one embodiment of the invention.

FIG. 2 is a block diagram illustrating an exemplary system for bond pricing according to one embodiment of the invention.

FIG. 3 is a block diagram illustrating an exemplary BPS server according to one embodiment of the invention.

FIGS. 3-26 show various screen shots of an exemplary bond pricing system user interface according to one embodiment of the invention.

FIG. 27 is a flowchart illustrating another exemplary method for bond pricing according to another embodiment of the invention.

FIG. 28 is a flowchart illustrating yet another exemplary method for bond pricing according to another embodiment of the invention.

FIG. 29 is a block diagram illustrating an exemplary system for bond pricing according to another embodiment of the invention.

### DETAILED DESCRIPTION OF THE INVENTION

The present invention is generally directed to systems and methods for bond pricing. A first set of embodiments of the present invention provide for a web-based platform (referred to as a bond pricing system or BPS) to efficiently create electronic bond pricing sheets in a proper format. For example, the BPS may accept inputs for all kinds of bond pricing parameters, including bond type, coupon rate, and even the underwriter's fee. The BPS may also provide for retrieval and selection of bond comparables, i.e., pricing for similar reference bonds. The system may automate the creation of PowerPoint® pricing sheets in a format to be sent to clients where the pricing sheets are editable such that information can be edited and/or copied to other larger books. With integration between DCM and Syndicate desks as well as coverage over multiple regions such as Europe, the Middle East and Africa (EMEA) and North America (NA), the system could provide the ability to view and assign bond pricing sheets across regions. The system may also generate and issue instant or future notifications to entities or teams involved in bond pricing (e.g., Syndicate desk and DCM desk) of their actions. Furthermore, the system may pull real-time market data from credit traders and collect latest bond reference data from sources such as Bloomberg. Historical pricing information may be stored and retrieved for comparison and analysis.

The first set of embodiments of the BPS system are advantageous over the traditional bond pricing approach in a number of ways, for example, leading to a faster turnaround time for responding to clients of the issuing bank, eliminating excessive manual overhead involved in producing and managing paper pricing sheets, improving timeliness of pricing sheet delivery and accountability between Syndicate and DCM desks, and facilitating metrics tracking for senior management with ability to drill down by variables such as issuer, sector, client, rating, desk, maturity, and user etc.

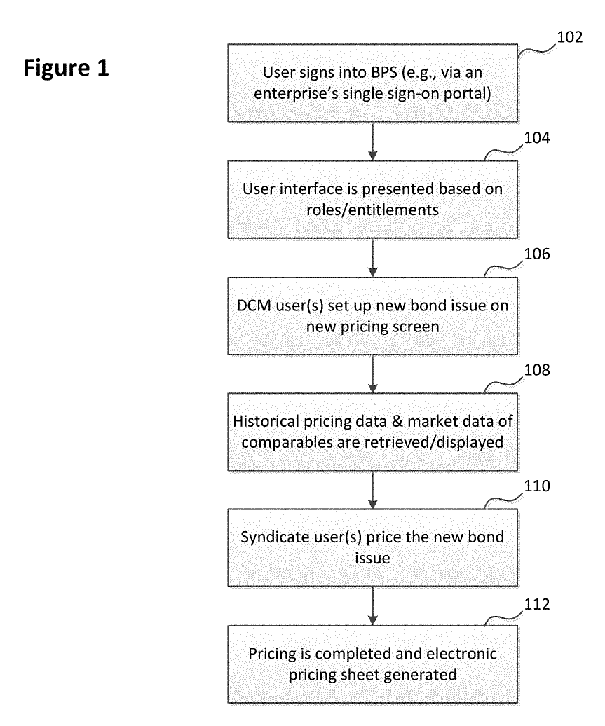

Referring to FIG. 1, there is shown a flowchart illustrating an exemplary method for bond pricing according to one embodiment of the invention.

In Step 102, a user may sign into the BPS. All the BPS functionalities and data may be secured on one or more computer servers which require user authentication before granting access. According to some embodiments of the present invention, the BPS may be a networked service hosted either internally on an enterprise network or publicly on a secured website. According to one particular embodiment, authorized employees of an underwriter firm may be able to use a single sign-on portal to log into the BPS. Other user authentication methods including the use of biometrics may also be employed.

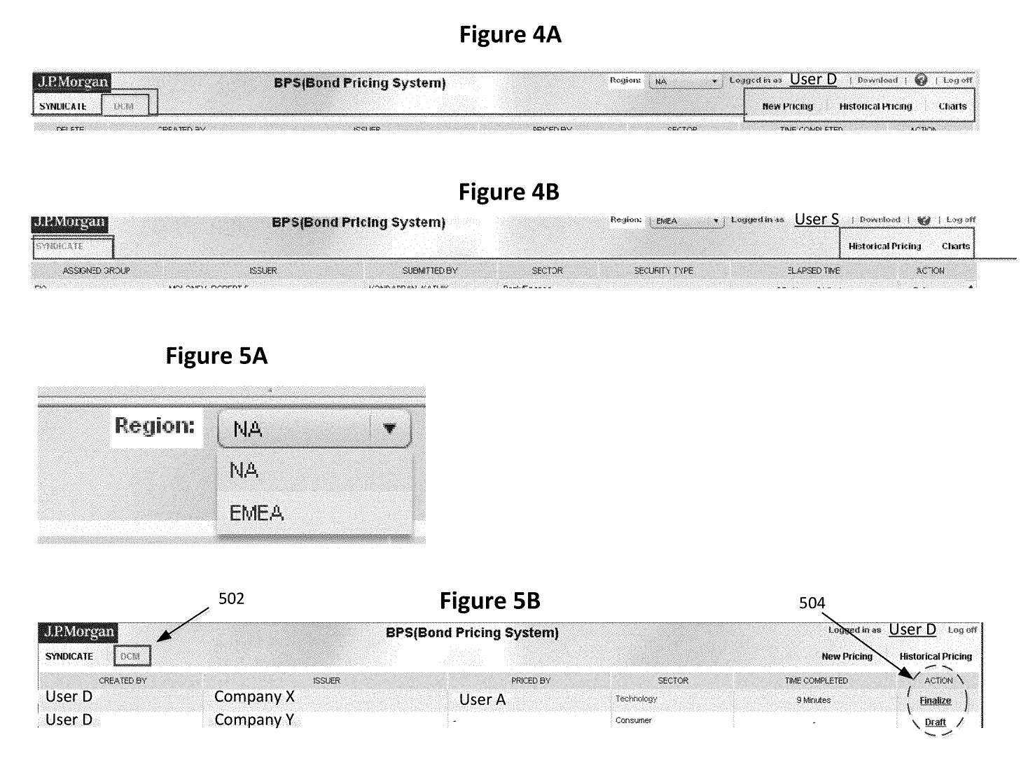

In Step 104, a user interface may be presented to an authenticated user based on his or her assigned roles and/or entitlements in the BPS. According to one embodiment of the invention, BPS users may have at least one of a DCM user role and a Syndicate user role. For example, a User D who is assigned a DCM user role may be presented with a corresponding screen (partially shown in FIG. 4A) where the DCM tab is active and User D can accordingly access DCM functionalities such as “New Pricing” and “Historical Pricing.” Alternatively, in some cases, User D may be assigned a dual role of both the DCM role and the Syndicate role, wherein User D could both conduct debt capital markets businesses and perform syndicate functions. As shown in FIG. 4A, both the DCM and SYNDICATE tabs may be active and selectable to show their respective set of functionalities and data. If an employee, User S, is only assigned a Syndicate role, then, as shown in FIG. 4B, only the SYNDICATE tab of the BPS may be visible. User S will not be able to access DCM functions such as setting up “New Pricing.”

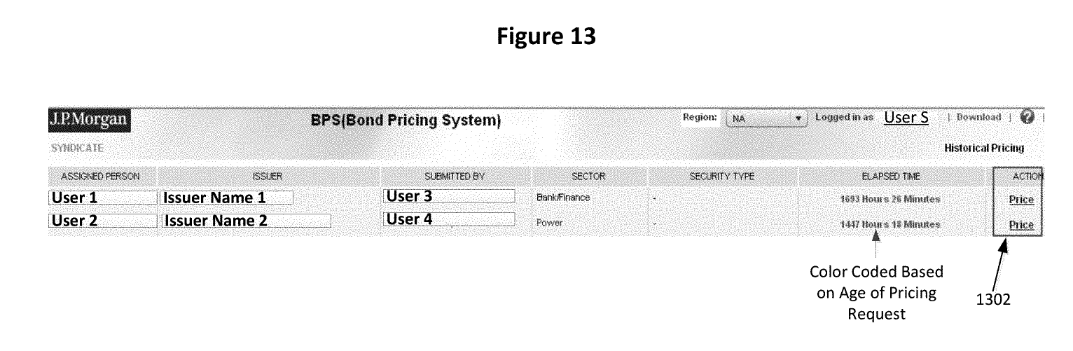

Upon signing in, the user may be greeted by a status screen. For example, a DCM user, User D, may be presented a DCM status page as partially shown in FIG. 5B. Under the DCM tab (502), there may be listed a number of bond pricing projects which User D is authorized to access. In this example in FIG. 5B, two pricing projects, for issuance by Company X and Company Y respectively, are listed. Each row may show information of that pricing project, such as the creator, issuer, and an action option (504). For instance, by clicking on the action links (504), the DCM user may open the corresponding pricing projects and choose to finalize bond pricing for Company X (e.g., on a DCM Completion page) or to continue setting up new pricing for Company Y (e.g., on a DCM New Pricing page). For a Syndicate user, a different status page may be presented, as will be described below in connection with FIG. 13.

Furthermore, upon logging into the BPS, a region option may be automatically selected based on the user's entitlement as to whether he or she is an EMEA or NA user. Or, as shown in FIG. 5A, the user may click on a drop-down menu to switch among the available region options. It should be noted that although only EMEA and NA are shown as region choices, the present invention is not limited to these two regions.

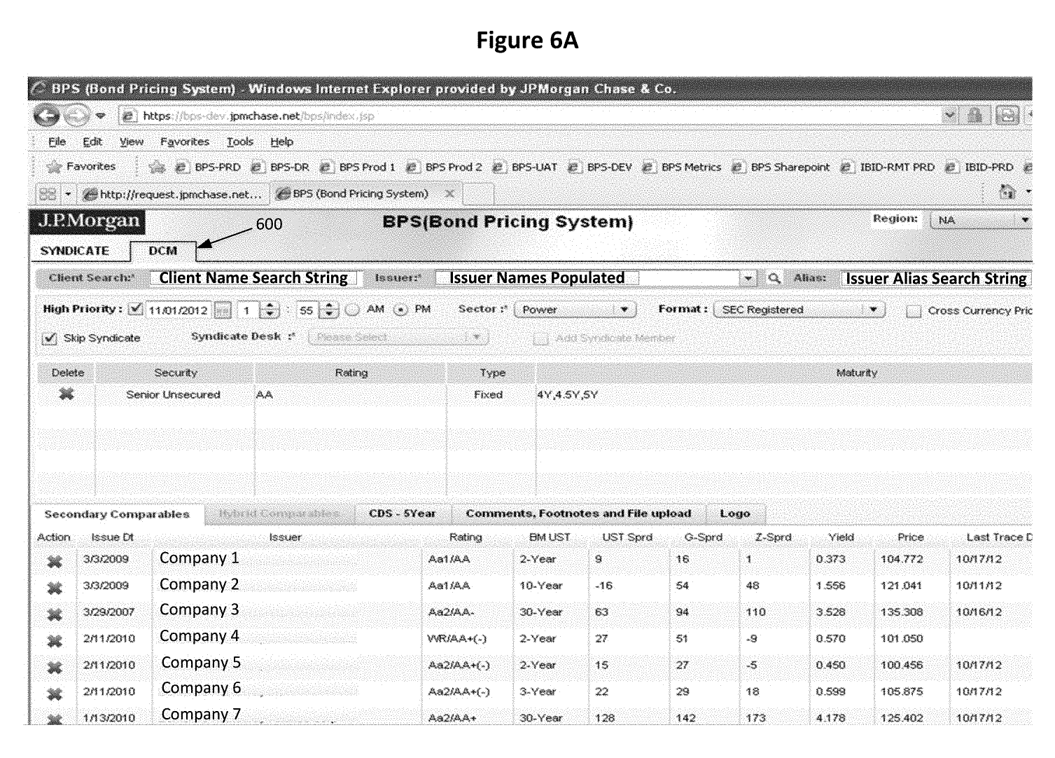

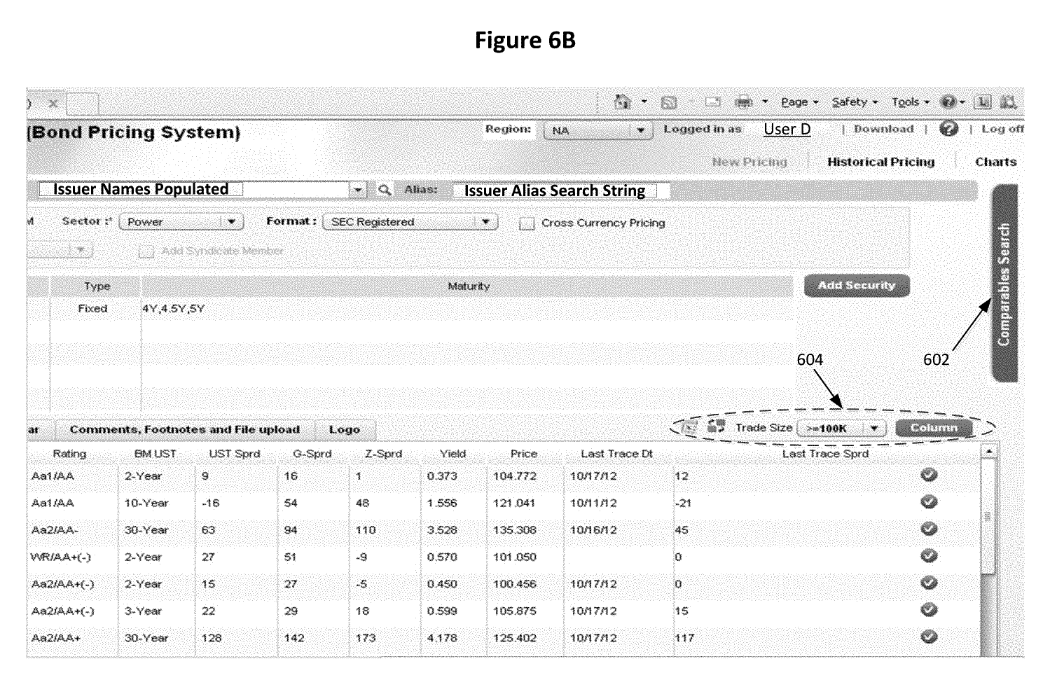

In Step 106, one or more DCM users may set up a new bond issue on the “New Pricing” page displayed by the BPS. FIGS. 6A and 6B show an exemplary DCM New Pricing page according to one embodiment of the present invention. Note the displayed screen is under the DCM tab 600. The New Pricing page facilitates the setup of bond pricing details. The main functions may include searching and adding clients, selecting industry sector and format for the new issue, and adding syndicate members, for example.

As shown in FIG. 6A, in a “Client Search” text entry box, a client name search string may be typed to execute a search for clients. This search may be supported by a BPS interface to a client database or a local copy of the client database (which may be synchronized periodically with a remote copy). The client name search string may be a full or partial name of the client, or it may be a stock ticker. In either case, the search string could cause a drop-down list of potential matches to be automatically populated and displayed. Once one of the clients is selected from the list, the issuer drop-down list may be automatically populated. For instance, once a holding company's name is entered or selected in the Client Search field, the issuer drop-down list will be populated with all subsidiaries and/or affiliates related to the holding company who are potential issuers associated with that client. Prior to any selection of a client, the issuer drop-down list may be initially populated with all the issuers the user has previously priced. According to one embodiment, the issuers can also be searched by alias name if the user has previously given alias names to issuers. In the alternative, the user could choose to search issuer names directly.

Regardless of the above-described search options, the user will need to select at least one issuer for a new bond issue and optionally pick an alias for the issuer before proceeding to set up pricing details. Optionally, the DCM user may designate the pricing as having “High Priority” by selecting a checkbox and setting a deadline for the pricing to be completed. The industry sector and format of the new issue may be selected with two pull-down menus respectively. Unless the “Skip Syndicate” box has been checked, the user can also select one or more Syndicate desk members to price the new bond.

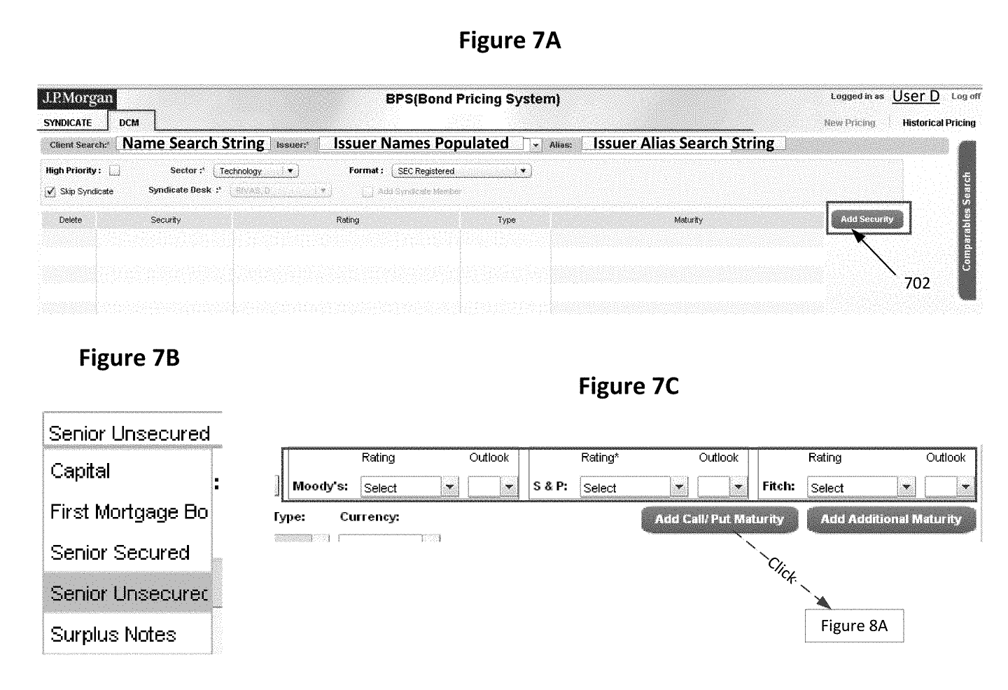

On the New Pricing page as shown in FIGS. 6A and 6B, User D also may set up a new bond issue by clicking an “Add Security” button. FIG. 7A shows a DCM New Pricing page with the Add Security button 702 before any new bond issue is set up. A click of the “Add Security” button 702 will cause a number of user input options to be simultaneously or sequentially displayed whereby the details of a new bond issue can be specified. For example, as shown in FIG. 7B, a pull-down menu could be provided for User D to select the bond type such as Capital, First Mortgage Bond, Senior Secured, Senior Unsecured, and Surplus Notes.

For senior pricings (i.e., Senior Secured, Senior Unsecured, Surplus Note, and First Mortgage) in North America Region, pull-down menus such as those shown in FIG. 7C may be provided to allow selection of required ratings of the new security, such as Moody's, Standard & Poor (S&P), and/or Fitch ratings.

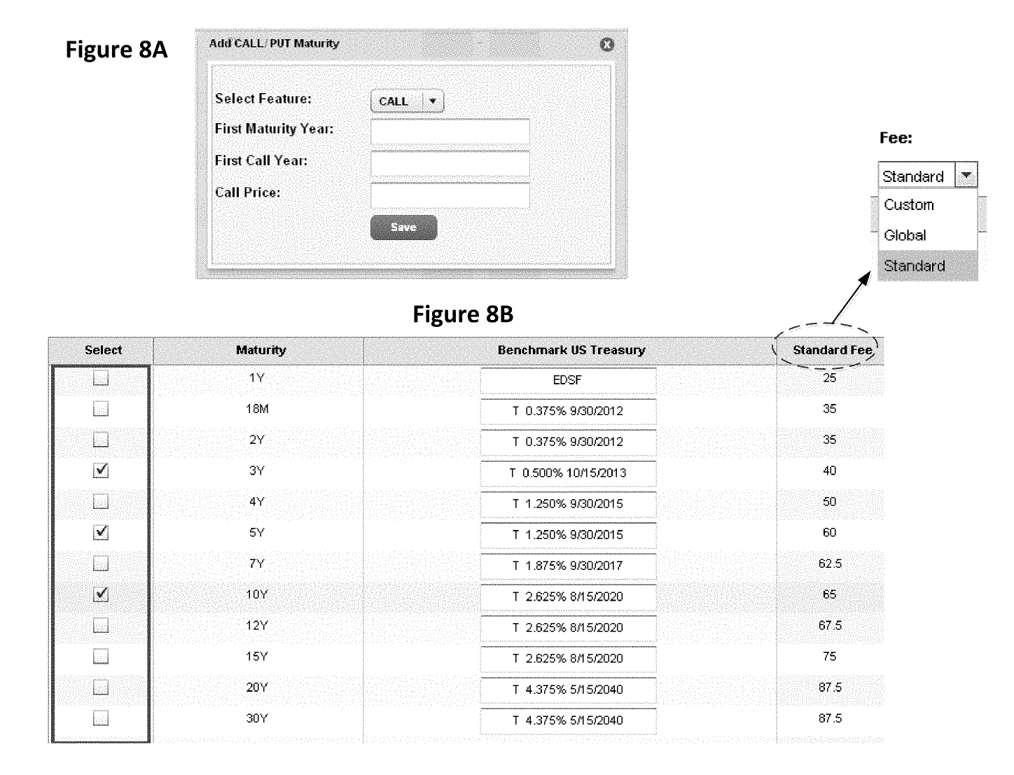

Optionally, User D could add a callable or putable maturity by clicking an “Add Call/Put Maturity” button which will pop out an entry box such as the one shown in FIG. 8A. In this entry box, the user may input details of the callable or putable maturity and then click Save.

One or more maturities may be selected for the new bond issue via a maturity selection table shown in FIG. 8B, for example, by ticking off the checkboxes in the left column. In addition to the maturities, the corresponding benchmark U.S. treasury bonds are also listed along with fees charged. Although only standard fees are shown here in FIG. 8B, other alternative fee types may be chosen by the user.

After being specified by the user, the above-described security details can be saved and become visible in the New Pricing page. One example is shown in FIG. 6A—the new security being a senior unsecured, fixed-rate bond with AA rating and maturities of 4, 4.5, or 5 years. If the user double-clicks on this security in FIG. 6A (or any other security if more are listed), the Add Security pop-out window can be opened to allow further editing of the security details.

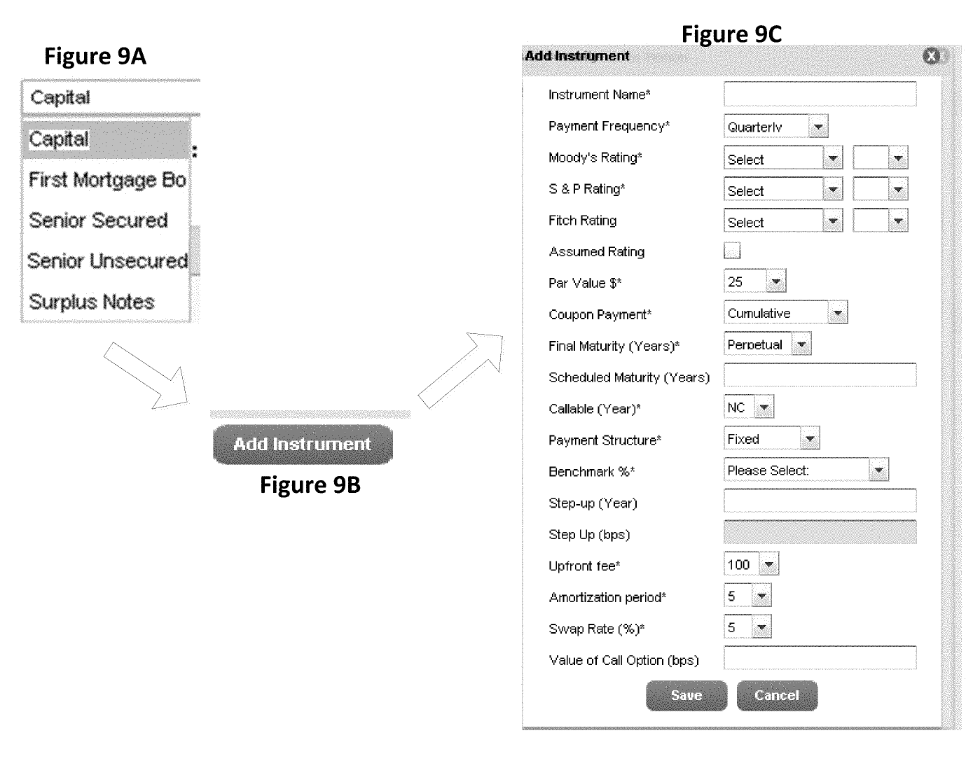

Other than the above-described senior pricings, a hybrid pricing may be performed for capital bonds in North America region. The hybrid pricing procedure may be started by selecting Capital in the pull-down menu shown in FIG. 9A (compare to FIG. 7B). Then, by clicking an “Add Instrument” button (FIG. 9B), a corresponding pop-out window is opened for input of instrument details. At least the mandatory information, such as instrument name, payment frequency, Moody's and S&P ratings, par value, coupon payment, final maturity, callable (year), payment structure, benchmark, upfront fee, amortization period, and swap rate, should be entered and saved.

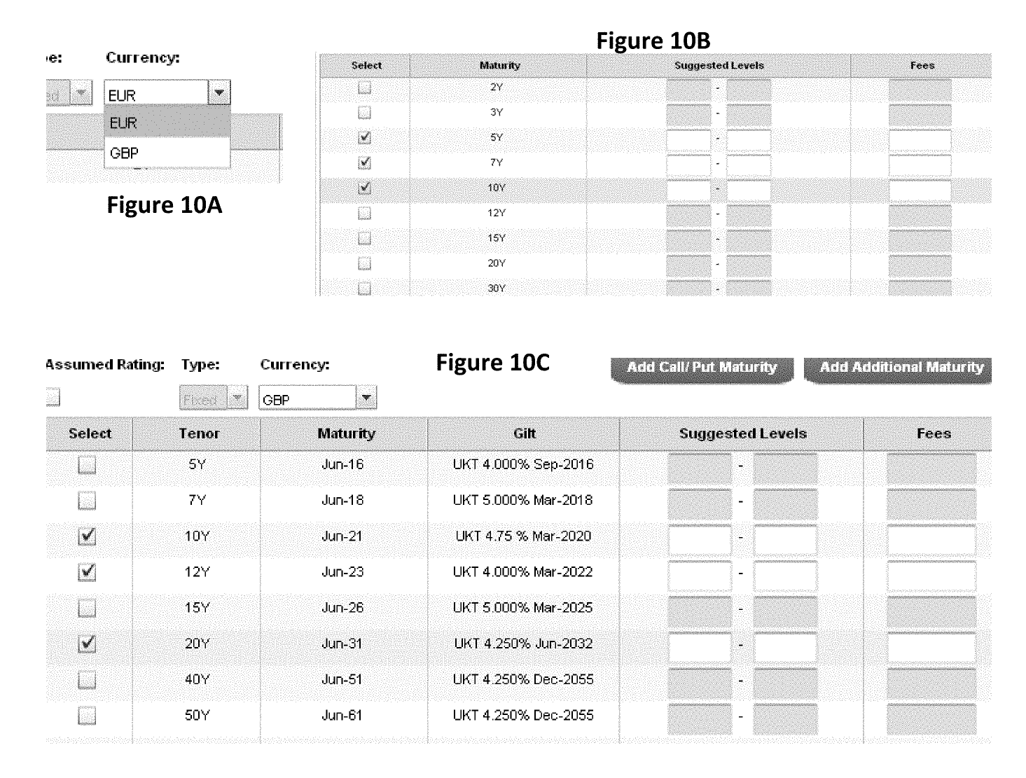

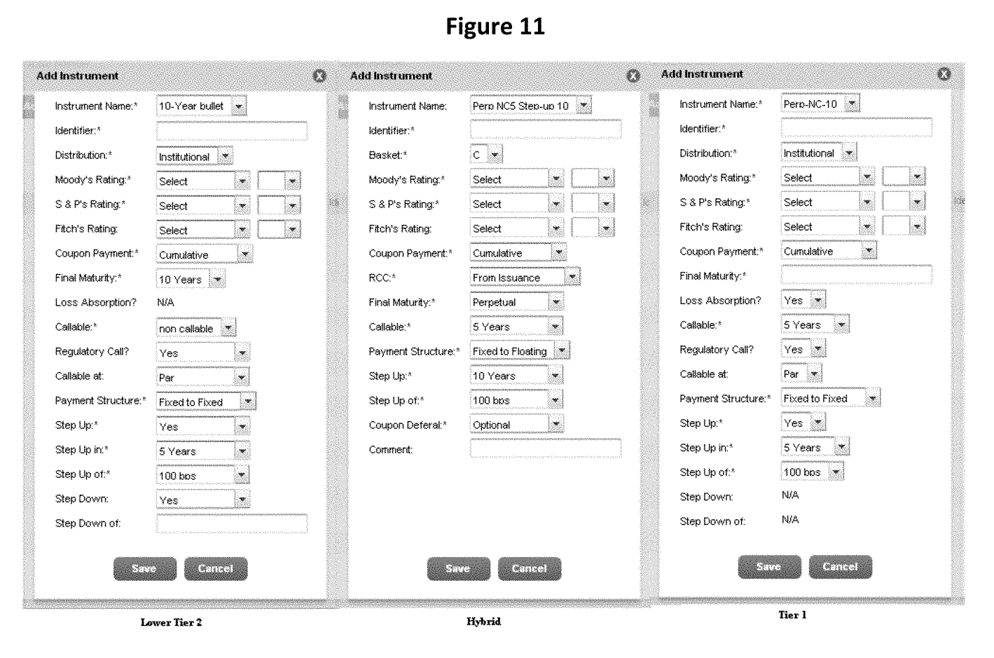

The new pricings for EMEA region may also include senior pricings and capital pricing options which follow user input procedures similar to those shown in FIGS. 7-9. A main difference is the selection of currency which may be initially specified with a pull-down menu as shown in FIG. 10A. It should be noted that currency options other than EURO (EUR) and British Pound (GBP) may be supported by the BPS. For EMEA senior pricings, if the selected currency is EUR, then the maturities may be selected via a user interface shown in FIG. 10B. If the selected currency is GBP, then the maturities may be selected via a user interface shown in FIG. 10C where the Gilt column lists the pricing of U.K. government bonds as corresponding to the different maturities. For EMEA capital pricing, multiple “Add Instrument” pop-out windows, such as those shown in FIG. 11, may be open for the user to enter details for each of the selected instrument type.

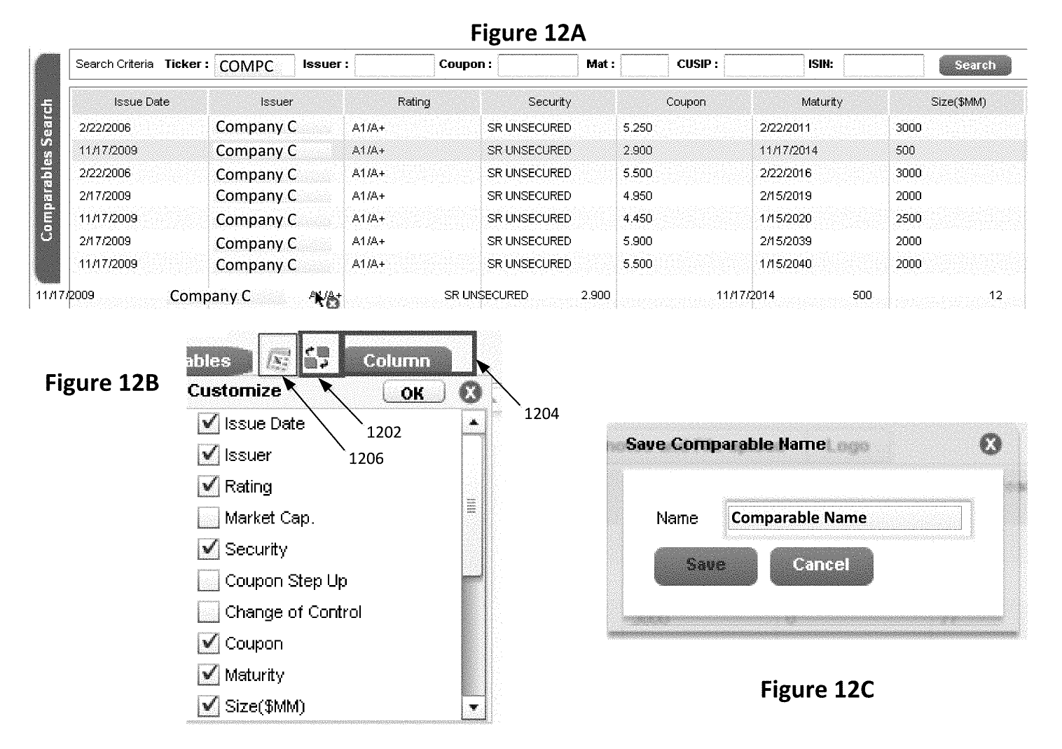

Referring back to the flowchart in FIG. 1, in Step 108, historical pricing data and market comparables data may be retrieved and displayed in the BPS. That is, the DCM New Pricing page may further facilitate the adding, searching, and customizing of comparables (i.e., other bond issues with similar characteristics as the new bond issue currently being set up). According to one embodiment of the present invention, the user may click on a “Comparables Search” bar 602 on the right of the DCM New Pricing page (see FIG. 6B) whereupon a pop-out search window as shown in FIG. 12A may allow the user to enter search criteria (e.g., ticker, issuer, coupon, maturity, CUSIP or ISIN). The comparables matching the search criteria are listed in the pop-out search window and the user may select one or more of the comparables by double-clicking on a row or dragging that row over to the DCM New Pricing page, for example, into the Secondary Comparables tab on the lower half of the New Pricing page as shown in FIG. 6A. The user can also customize the display of comparables by first clicking on some icons shown in the comparables portion of the DCM New Pricing page (see icons 604 in FIG. 6A, some of which are enlarged in FIG. 12B). For example, the user may click on the Customize Columns button 1202 and then select the checkboxes next to the column headings to hide or display columns, or the user may click on the “Column” button 1204 to add an additional column to the comparables table. Furthermore, a click on the Excel icon 1206 will open the comparables in a Microsoft Excel spreadsheet or equivalents.

According to embodiments of the present invention, the comparables table may include one or more columns displaying real-time market data, such as U.S. Treasury Spread (NA), Z-Spread (EURO), and Spread to Benchmark (GBP), which data points may be constantly (or periodically) updated via data feeds from their respective data sources and may tick in real-time or near-real-time. According to some embodiments of the present invention, all fields in the comparables table may be editable. If the user chose to override the market data, the fields such as Price, Yield or UST Spread may recalculate automatically based on user inputs.

The customized comparables table can then be named and saved. The user may click a “Save Comparables” button and then provide a name for the comparables table to be saved in a pop-out window as shown in FIG. 12C.

In addition to the comparable searches, the BPS also facilitates the search of credit default swap (CDS) data from the market or traders. Similar to the “Comparables Search” bar 602, the user may click on a “CDS Search” bar (not shown) to search for CDS data relevant to the new bond issue and include selected search results in a CDS table which may display the latest S&P and Moody's ratings in addition to the 5-Year CDS levels.

Next to the “Secondary Comparables” and “CDS—5 Year” tabs there is provided a “Comments, Footnotes and File Upload” tab through which the user may enter comments and footnotes or upload a file (e.g., an Excel file with a comparables table) from the user's computer to the BPS system. Any comments, footnotes, or uploaded files may be visible to the Syndicate member doing the pricing on the particular new issue.

After completion of Steps 106 and 108, when the DCM user has finished entering the information to set up a new bond issue, the user may click on a “Save” button to save the pricing as a draft and/or click a “Submit for Pricing” to submit the pricing for subsequent processing (e.g., by the Syndicate desk).

Next, in Step 110, one or more Syndicate users may price the new bond issue. For example, when a Syndicate user, User S, logs into the BPS, a Syndicate status page may be displayed, as shown in FIG. 13. This status page may list all the bond pricing projects accessible by User S. The displayed project information may include, for example, identification of the Syndicate person or group assigned to the project, issuer name, name of the DCM user who submitted the pricing, sector, and security type, etc. The elapsed time (i.e., the amount of time in which pricing has been sitting in the Syndicate queue during business hours) may also be displayed for each pricing project and could be color-coded to indicate the age (or urgency) of the pricing request. For example, for requests that are less than two hours old, the Elapsed Time may be shown in green; for requests that have spent more than four hours in the queue, the Elapsed Time may be shown in red; and the rest of the requests, between two hours and four hours of age, may be shown in an amber color. Similar to the DCM status page, the Syndicate status page may also display action options 1302 for the pricing projects. A typical action option is “Price” which link can be clicked to open the Syndicate pricing page details for the desired pricing project.

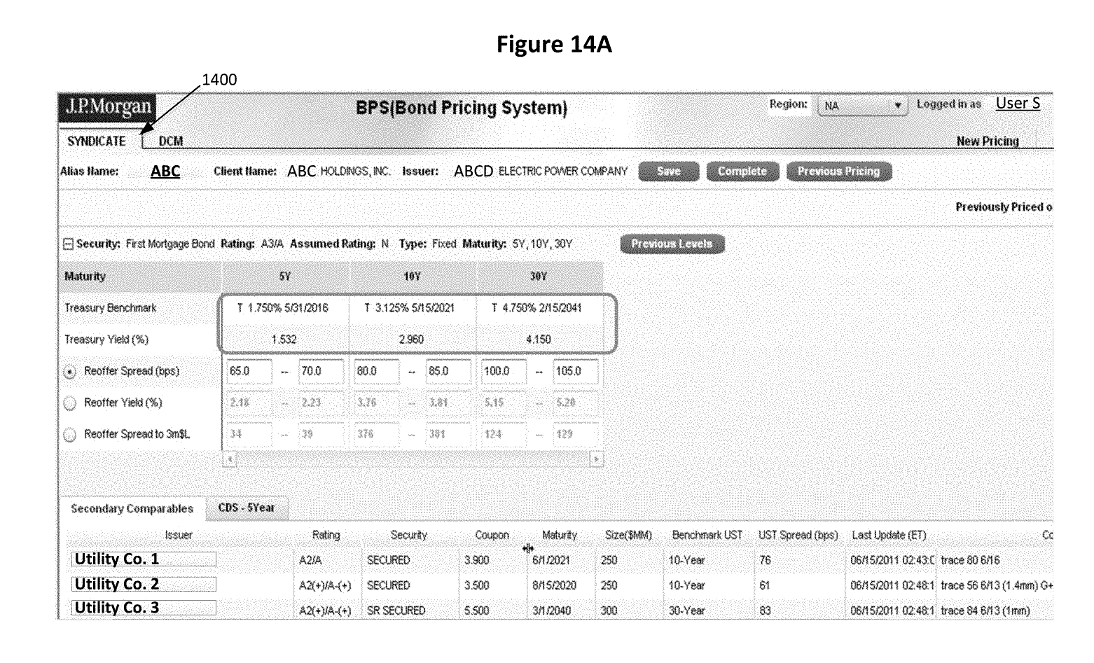

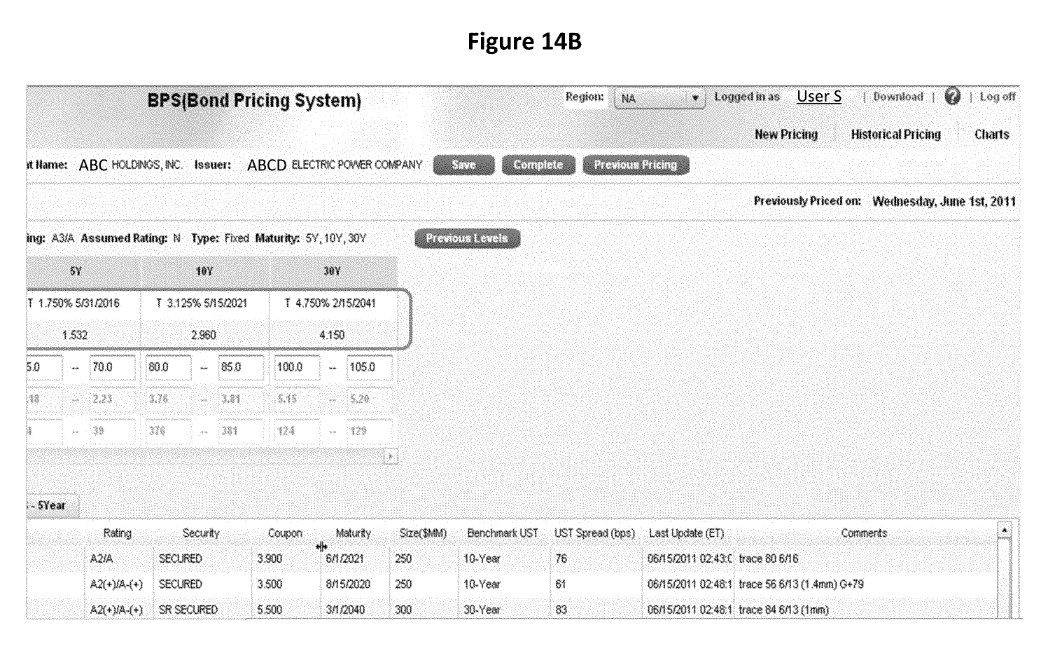

FIGS. 14A and 14B show an exemplary Syndicate pricing page according to one embodiment of the present invention. Note the displayed screen is under the Syndicate tab 1400. This pricing page facilitates the analysis and entry of the most critical pricing parameters by the Syndicate user, for example, User S. There may be procedures for pricing a new bond issue for different regions such as NA and EMEA.

As shown in FIG. 14A, User S may choose to price a new bond issue for ABCD Electric Power Company for client ABC Holdings, Inc. The basic details of the new bond, as shown below the client and issuer names, may have been set by a DCM user, for example, as a fixed-rate type, first mortgage bond with A3/A rating and 5-year, 10-year, and 30-year maturities. Further below the security information there are shown some editable fields (along with treasury benchmark and treasury yield data for the relevant maturities as reference data), providing the options of pricing the bond based on reoffer spread, reoffer yield, or reoffer spread to 3m$L. By clicking on one of the radio buttons for the pricing options, the corresponding row of pricing parameters will be automatically populated from the last pricing completed for the issuer with those maturities. Information concerning the last pricing may be displayed to the top right corner of the Syndicate pricing page (see FIG. 14B, showing “Previously Priced on: Wednesday, Jun. 1, 2011). That selected row will also become editable for the user to adjust the pricing levels while the other rows become grayed out. The pricing levels may be entered as specific values or ranges. The reference data of treasury benchmark and treasury yield may tick with the market in substantial real-time. Any move in the market may impact the grayed out fields in the pricing details.

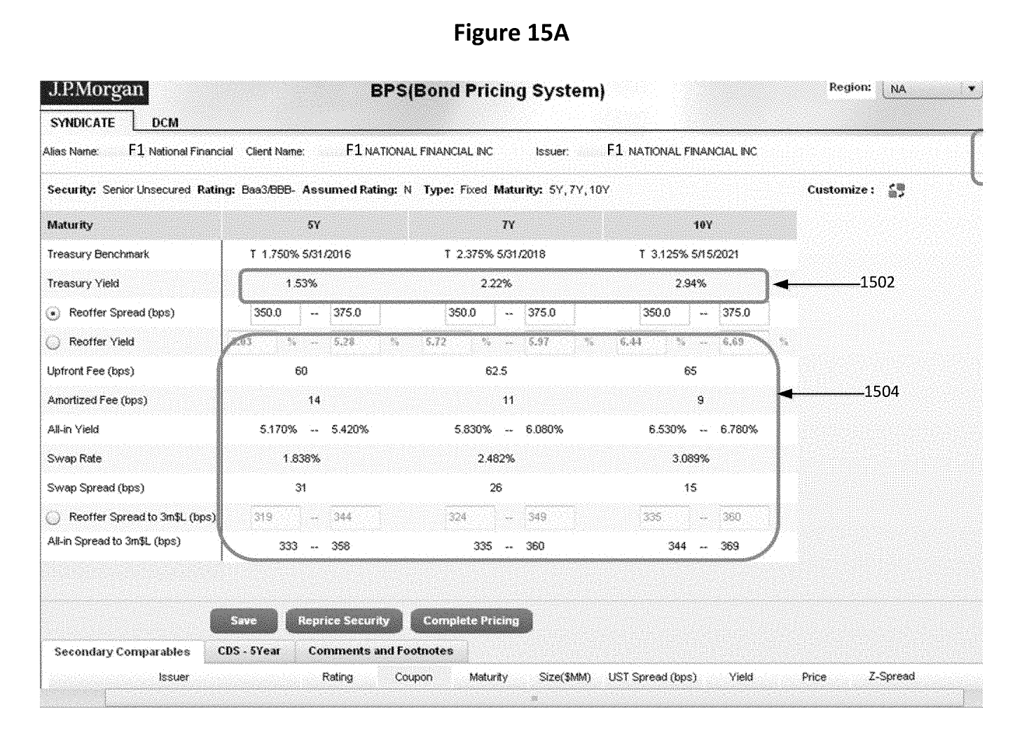

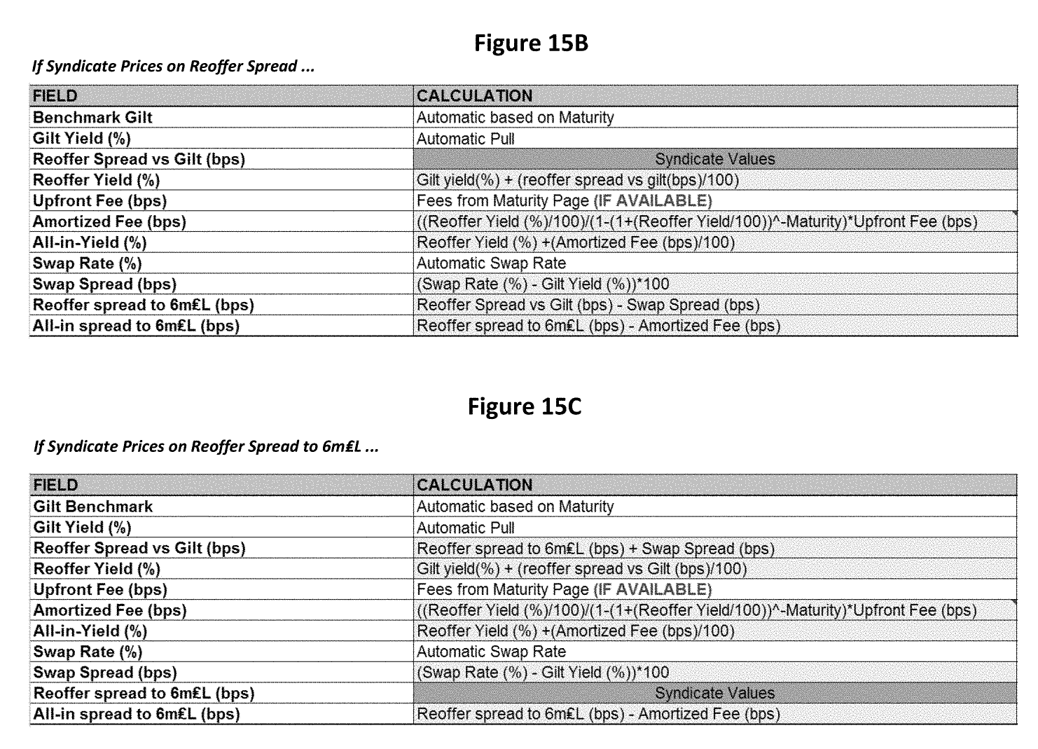

FIG. 15 shows a part of another exemplary Syndicate pricing page wherein some of the pricing option rows are expanded. While the Treasury Yield data (in box 1502) are ticking live with the market, the various parameters (in box 1504) are updated accordingly based on automated instant calculations.

Similarly, for the EMEA region, the new bond issues may be priced with different options depending on the currency. For example, for GBP, the options may include “Re-offer Spread vs. Gilt” or “Re-offer vs. 6m.” For EUR, the pricing option may be “Re-offer Spread vs. midswaps.” As the user enter or adjust one pricing parameter, all other related parameter fields may automatically populate, calculate and/or update.

FIGS. 15B and 15C show some exemplary data entry and calculation mechanisms that support the portion of the Syndicate pricing page where pricing details are entered or displayed. FIG. 15B shows pricing details table for pricing a “Senior Unsecured, Covered” bond in British pound (GBP) when the Syndicate user chooses to price it on Reoffer Spread. In this case, the “Reoffer Spread vs. Gilt (bps)” field is where the Syndicate user can tinker with, i.e., by entering or adjusting the spread in basis points (bps). The other fields are either automatically calculated based on the spread value (e.g., the “Reoffer spread to 6m [symbol] L (bps)” value) or automatically pulled from their respective data sources (e.g., the “Gilt Yield (%)” field). Similarly, FIG. 15C shows pricing details table for pricing a “Senior Unsecured, Covered” bond in British pound (GBP) when the Syndicate user chooses to price it on Reoffer Spread to 6m [symbol] L. Again, only the “Reoffer spread to 6m [symbol] L (bps)” field takes input from the user while the rest of the table fields are automatically updated based on calculations or data feeds.

The Syndicate user may also access and write comments. The DCM pricing comments may be displayed to the Syndicate user but not editable. A separate Syndicate pricing comments field may be editable by the Syndicate user.

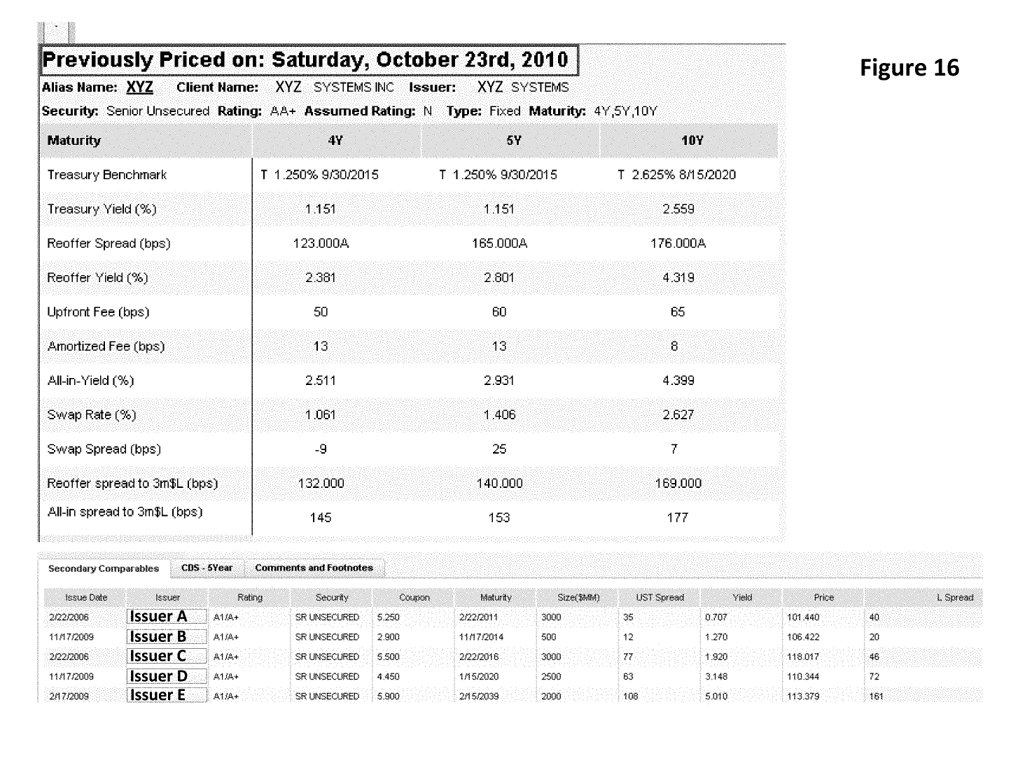

On the Syndicate pricing page, the user may also click on a “Previous Pricing” button (see FIG. 14A) to access any previous pricing details. FIG. 16 shows one example of such previous pricing details for bonds issued by “XYZ Systems” with 4-year, 5-year, and 10-year maturities which were “Previously Priced on: Saturday, Oct. 23, 2010.” Also displayed with the previous pricing details may be Secondary Comparables data, CDS-5 Year data, and any comments and footnotes.

While on the Syndicate pricing page, the user may further access comparables and CDS data related to the new bond issue that is currently being priced. For example, the user may navigate to the bottom portion of the Syndicate pricing page (see FIGS. 14A and 14B) and click on the “Secondary Comparables” tab or the “CDS-5 Year” tab to view the respective data added by the DCM user.

Finally, the Syndicate user may either save or complete the pricing by clicking on the “Save” or “Complete” buttons shown on the top of the Syndicate pricing page as shown in FIG. 14A. A click on the “Save” button will save the pricing without completing it, so that it could be opened again from the Syndicate queue. A click on the “Complete” button will finish the pricing, remove it from the Syndicate queue, and forward the pricing to the DCM desk for pricing completion. According to some embodiments, the pricing may also be locked to prevent others from making changes.

Referring again to the flowchart in FIG. 1, in Step 112, the pricing of the new bond issue may be completed (typically by the DCM desk) and an electronic pricing sheet may be generated accordingly.

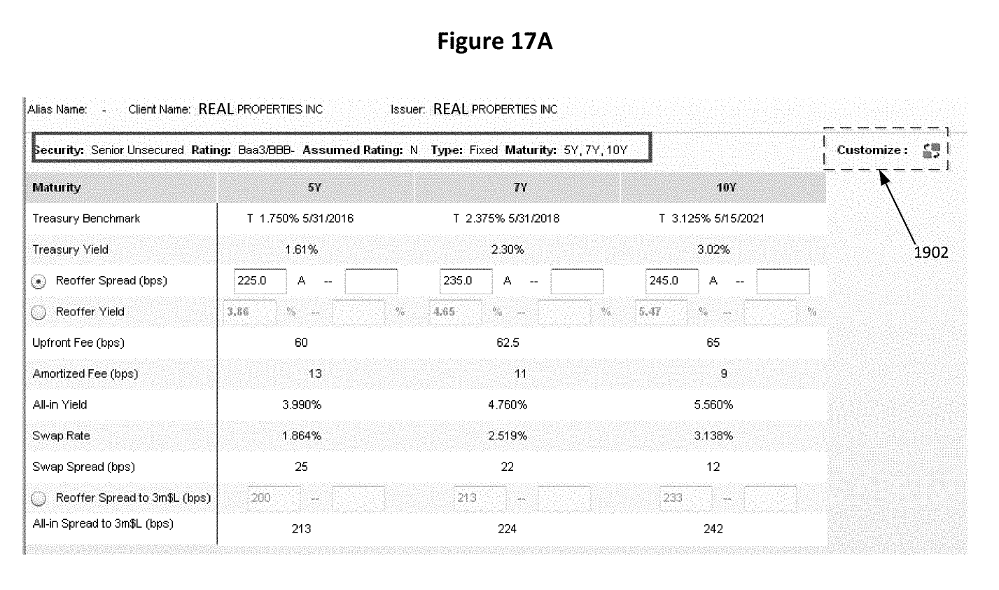

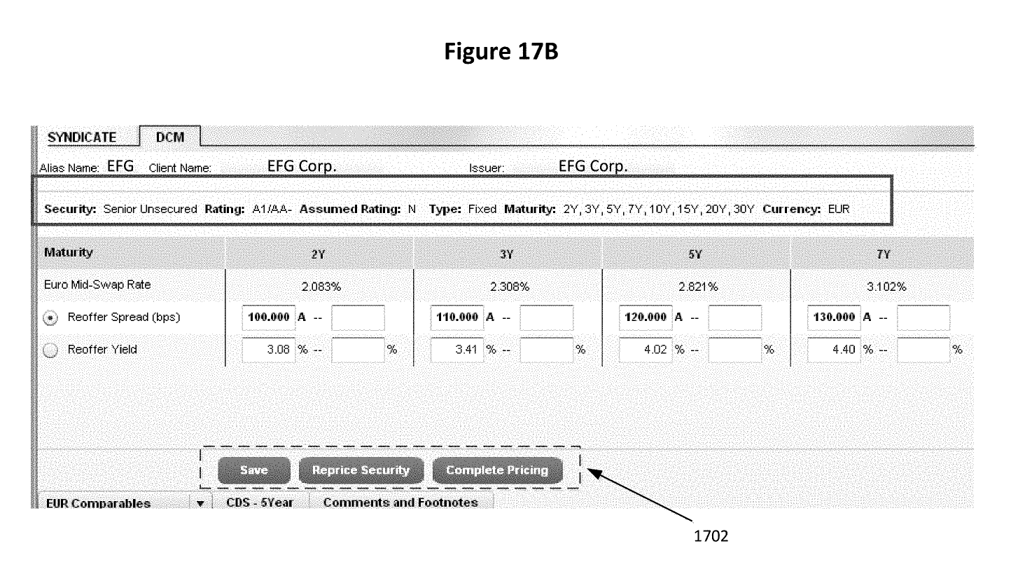

In this step, the DCM user may locate the new bond to be priced on the DCM Completion page of the BPS (partially shown in FIGS. 17A and 17B), make any change or adjustment to the pricing levels entered by the Syndicate desk (FIGS. 17A and 17B), access the comparables data and any comments or footnotes (FIG. 17B), and then choose to save the pricing without completion, re-price the new issue (which changes the pricing status in DCM queue from Finalize to Draft), or complete the pricing (i.e., finish pricing and add the finalized pricing details to historical data).

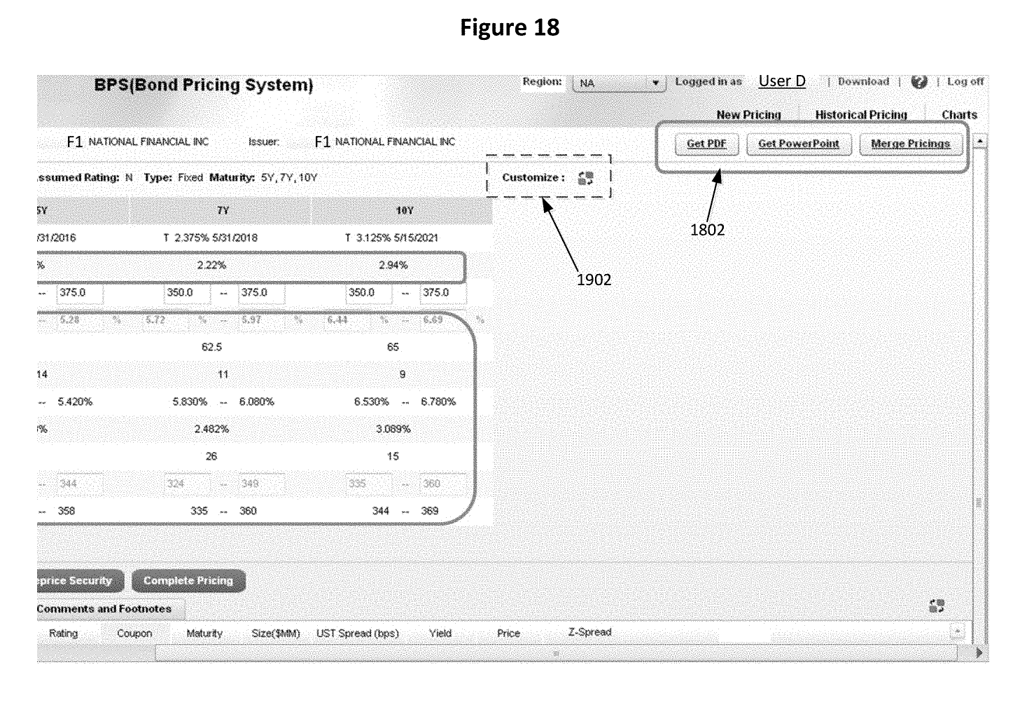

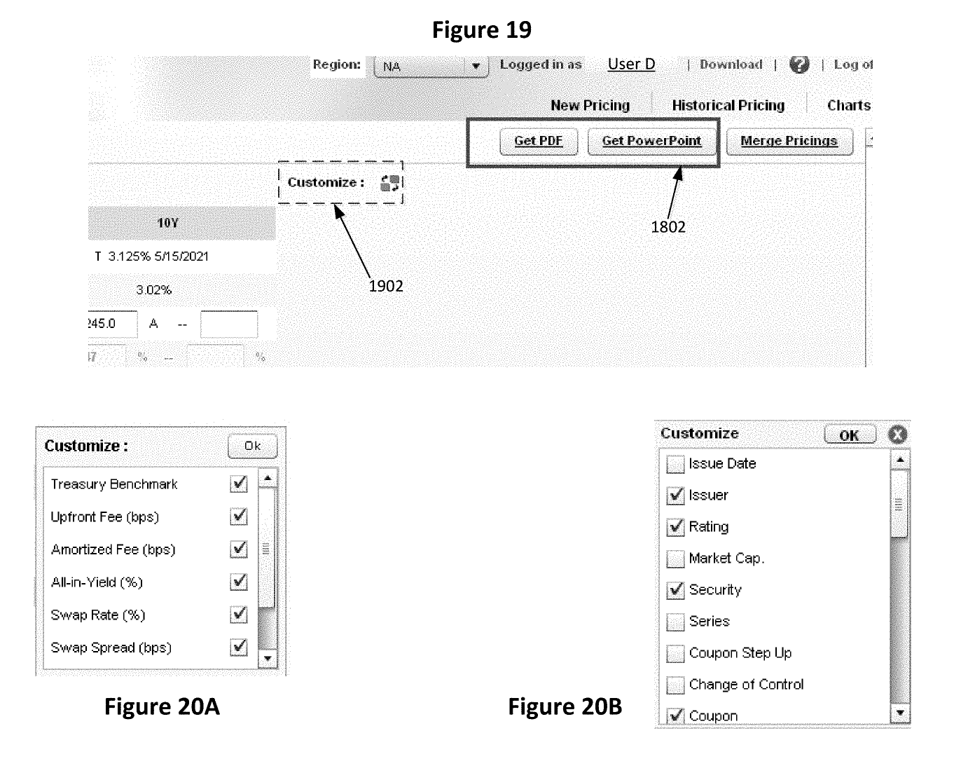

After completing the pricing, the DCM user, here User D, may navigate to the “Get PDF” and “Get PowerPoint” options (1802) as shown in FIGS. 18 and 19 to generate an electronic pricing sheet in a desired format. For example, the BPS may generate pricing sheets in PDF and/or PowerPoint formats in accordance with predetermined templates. According to one embodiment of the present invention, the pricing details visible in the BPS user interface may be the ones exported to the electronic pricing sheet. By clicking on a Customize icon 1902 (see FIGS. 17A, 18 and 19) and then using pop-out windows (e.g., FIGS. 20A and 20B), the user may further customize the content and format of the display of pricing details and comparables both as displayed in the BPS user interface and as laid out in the electronic pricing sheet. According to another embodiment, the electronic pricing sheets or contents thereof may be incorporated into client presentations or presented in a “pitch book” for marketing purposes, for example.

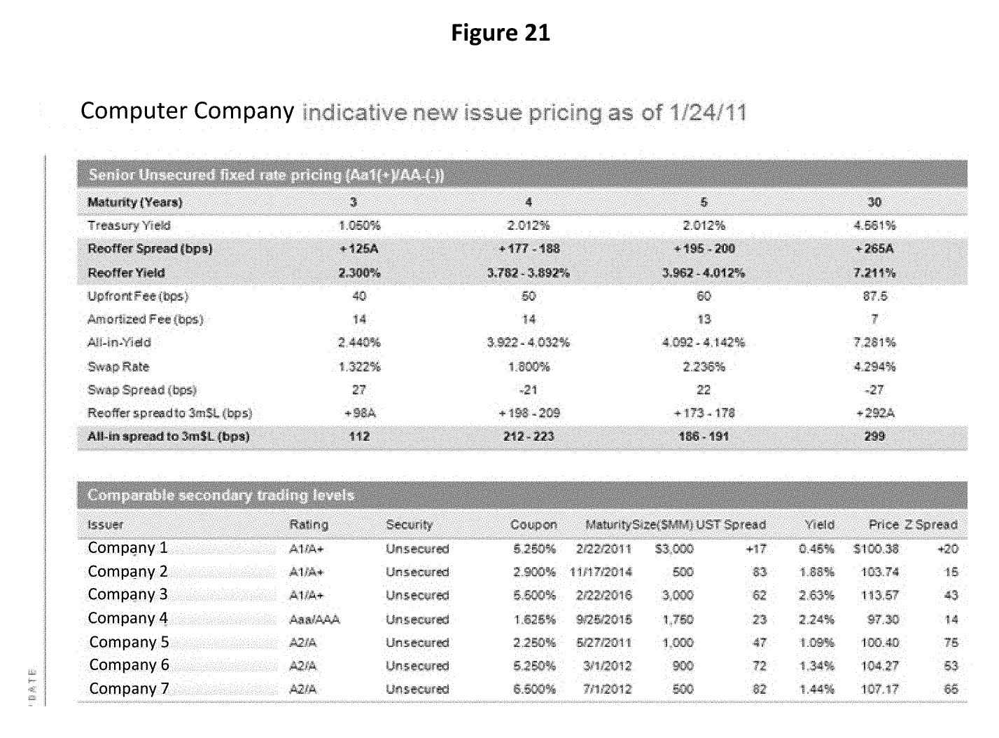

FIG. 21 shows an exemplary pricing sheet generated by the BPS according to one embodiment of the present invention. In an exemplary single-page format, this pricing sheet is generated for issuer Computer Company for new bond issues with 3-year, 4-year, 5-year, 30-year maturities. The top half of the pricing sheet shows pricing details for each of the maturities along with Treasury Yield data as reference, while in contrast the bottom half shows comparable pricing on the secondary market. This type of electronic pricing sheet may be easily delivered to client issuers and/or shared among the underwriter personnel.

In addition, the user may access a Historical Pricing page in the BPS to search for previous pricings and export the data to PDF or PPT as well. Similarly, the user may access comparables and/or CDS data as well as comments and footnotes and export such information too. The use may also access a Charts page (not shown) to search and open charts or graphs related to a specified client or issuer. Not only can the charts be displayed via the user interface, they can also be exported or saved to the user's local computer. At least some of the additional information may be included with the electronic pricing and delivered as a package to the client issuer and/or other parties.

From the above description, it may appreciated that the BPS facilitates a series of actions by DCM users and Syndicate users to price new bond issues. Not only does the BPS platform make it more convenient and efficient for users to set up new pricings, collect historical pricing data and market comparables data, and perform analysis to achieve desired pricing levels, the BPS may also implement workflow control to promote collaboration among parties or users involved in the bond pricing process. For example, apart from the above-mentioned DCM and Syndicate pricing queues, the BPS may generate notifications to drive the bond pricing workflow.

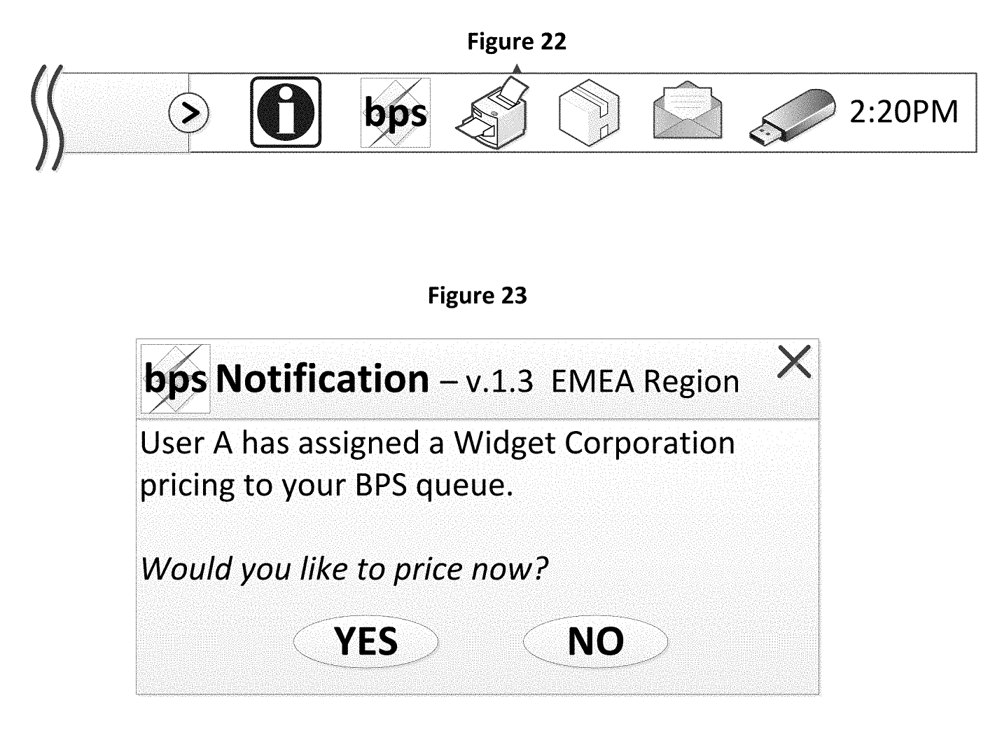

According to some embodiments of the present invention, the BPS software may include a module or function that runs in the background of user's work station or other computing device to receive, process, and display BPS notifications and to process user responses to the notifications. Alternatively, the notification functions may be implemented with a software application referred to as BPS Notification System. For instance, as shown in FIG. 22, a BPS icon may be shown in a Windows status bar and may provide instant notifications to a user when a pricing has been assigned to the user's queue. For example, when a new notification comes in, the BPS icon may flash and pop out a window such as those shown in FIGS. 23-25 to alert or remind the user of pricing related actions.

FIG. 23 shows an exemplary notification window for an EMEA region pricing project, informing the user that “User A has assigned Widget Corporation pricing” to the user's BPS queue and asking whether the user wants to price this Widget Corporation's new bond issue now. This notification alerts the user of a new pricing assigned by the DCM desk to the Syndicate desk. The user can respond by clicking on Yes or No buttons, where a click on the Yes button may open up the appropriate BPS pricing page for this particular pricing project while a click on the No button would dismiss the notification window.

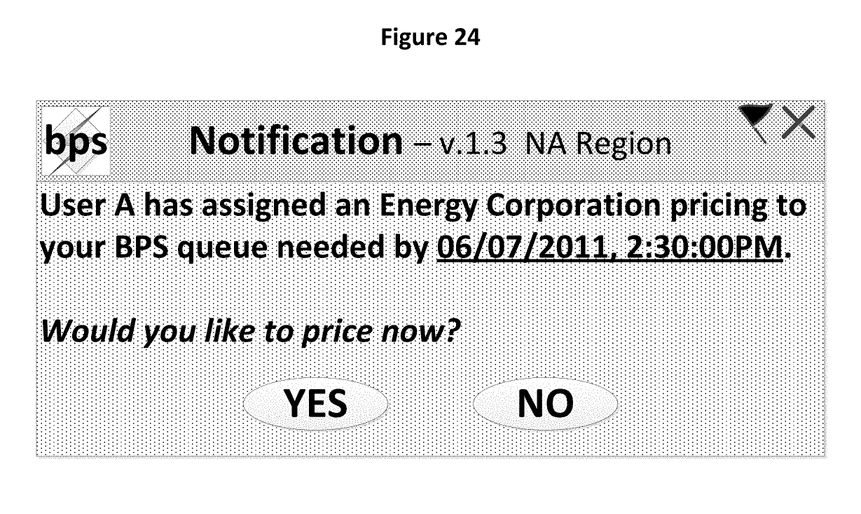

For a more urgent task, such as a high-priority pricing to be completed sooner than other pricings, a notification window with visual cues for the urgency or priority may be generated. One example is shown in FIG. 24 where the high-priority notification window may be shown in a red color, with a little red flag, or otherwise in a form that can more easily catch the user's attention. The high-priority, urgent notification may also specify the date and time by which the pricing should be completed by the Syndicate user.

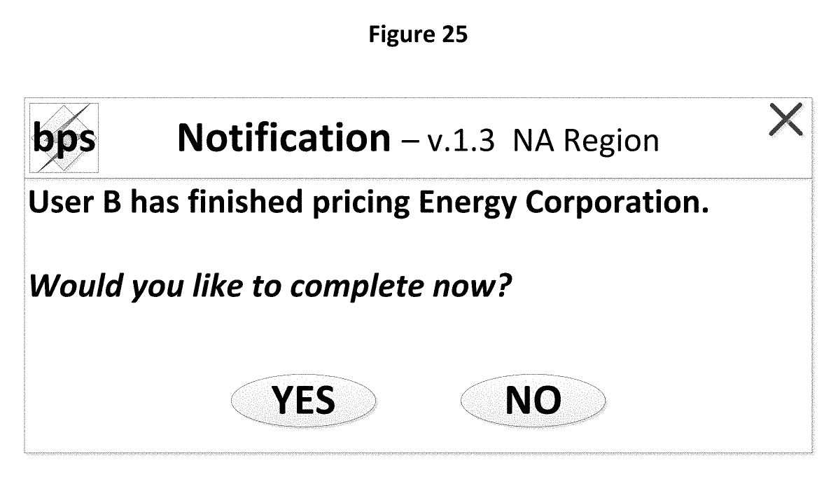

FIG. 25 shows another exemplary notification window whereby the Syndicate desk assigns a pricing to the DCM desk. This notification informs a DCM user that a Syndicate user “User B has finished pricing Energy Corporation” and asks the DCM user whether to complete the pricing now. By clicking on the Yes button, the DCM user may be taken to the DCM Completion page to finalize the pricing.

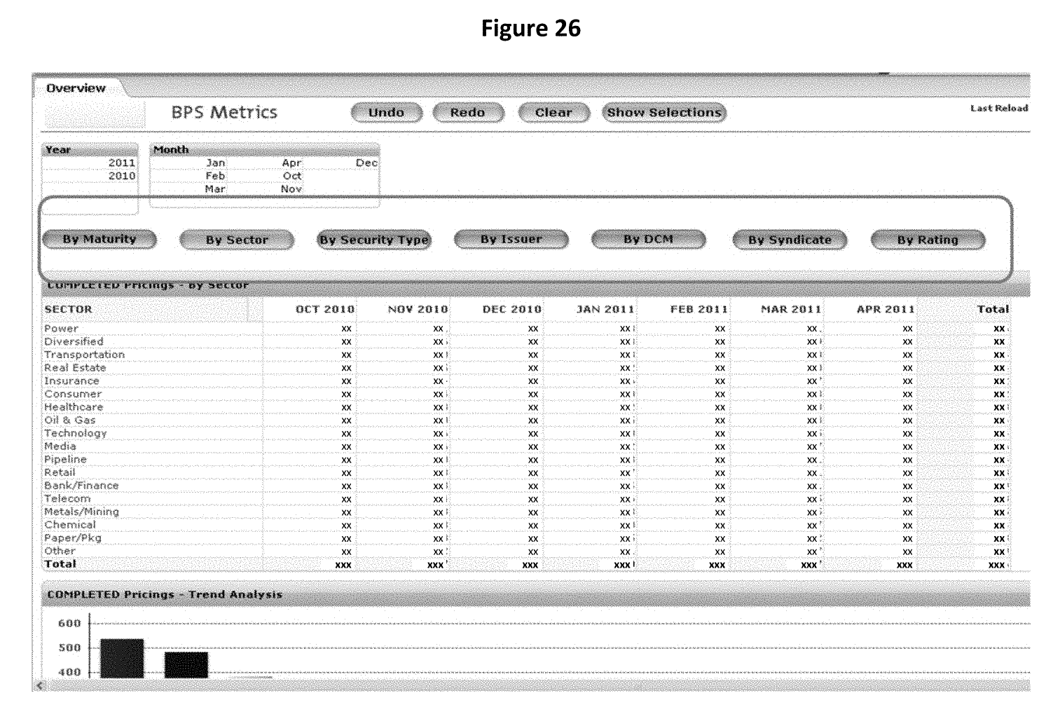

The BPS may also provide a Metrics page, such as the one shown in FIG. 26, that provides statistical data on the pricing projects handled with the BPS. An authorized user may use the Metrics page to review the use of the BPS system in bond pricing. The pricing projects may be tallied by month and year. The user can also drilled down by various criteria such as maturity, industry sector, security type, issuer, DCM desk, Syndicate desk, or ratings.

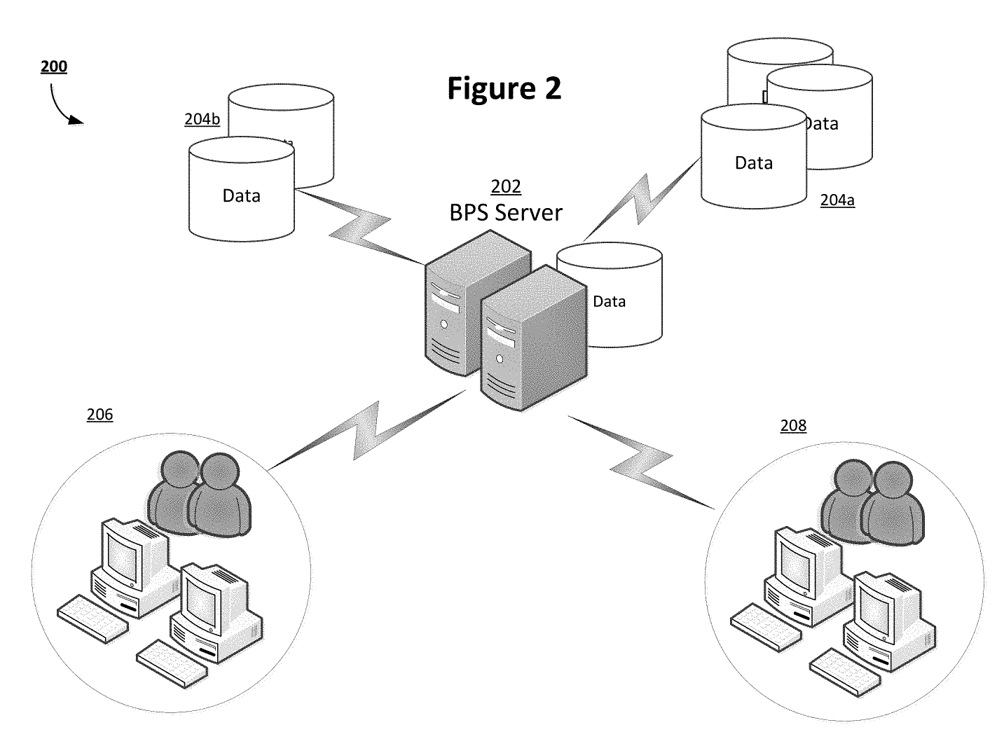

FIG. 2 is a block diagram illustrating an exemplary system 200 for bond pricing according to one embodiment of the invention.

As shown, the system 200 (and related software) is implemented based on computing equipment. Generally, it should be noted that the components depicted and described herein may be, or include, a computer or multiple computers. Although the components are sometimes shown as discrete units, they may be interconnected or combined. The components may be described in the general context of computer-executable instructions, such as program modules, being executed by a computer. Generally, program modules include routines, programs, objects, applications, components, data structures, etc., that perform particular tasks or implement particular abstract data types. For example, a server may comprise a single server or a group of servers used to service users. Additionally, a server may comprise a front-end web server and a back-end database server. Alternatively, those functions can be integrated into a single server device.

Those skilled in the art will appreciate that the invention may be practiced with various computer system configurations, including hand-held wireless devices such as mobile phones, tablets or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Computing devices (e.g., mobile devices, lap-tops, desk-tops, etc.) typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as the Macintosh® OS or Apple iOS operating systems, Google Android operating system (and variations thereof), Microsoft Windows® operating system (desktop and/or mobile version), the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Apache™ operating system, an OpenStep™ operating system or another operating system or platform.

User applications may be so-called stand-alone applications executing on user devices or they may be client-server type applications that interface with server-side components. They may include applications provided by the server, such as Java Applets, that may be delivered with web pages.

The memory will include at least one set of instructions that is either permanently or temporarily stored. The processor executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The computer may include a plurality of software processing modules stored in a memory as described herein and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

In addition, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the invention as described herein, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described herein is performed by various components and various memories. However, it is appreciated that the processing performed by two distinct components as described herein may, in accordance with a further embodiment of the invention, be performed by a single component. Further, the processing performed by one distinct component as described herein may be performed by two distinct components. In a similar manner, the memory storage performed by two distinct memory portions as described herein may, in accordance with a further embodiment of the invention, be performed by a single memory portion. Further, the memory storage performed by one distinct memory portion as described herein may be performed by two memory portions, for example.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. Input devices include those that recognize hand movements or gestures, such as in the case of gesture set supported by Android or the swipe movements recognized in iOS-based devices. These and other input devices are often connected to the processing unit through a user input interface that is coupled to the system bus, but may be connected by other interface and bus structures, such as a parallel port, game port or a universal serial bus (USB).

A user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed herein, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the invention, it is not necessary that a human user actually interact with a user interface used by the processing machine of the invention. Rather, it is also contemplated that the user interface of the invention might interact, i.e., convey and receive information, with another processing machine, rather than a human user. Further, it is contemplated that a user interface utilized in the invention may interact partially with another processing machine or processing machines, while also interacting partially with a human user.

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described herein.

Various networks may be implemented in accordance with embodiments of the invention, including a wired or wireless local area network (LAN) and a wide area network (WAN), the Internet, wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism.

Computers may be connected over the Internet, an Intranet, Extranet, Ethernet, or any other system that provides communications. Some suitable communications protocols may include TCP/IP, UDP, or OSI, for example. For wireless communications, communications protocols may include Bluetooth, Zigbee, IrDa, Wi-Fi, 2G, 3G, Ultra-Wideband and Long Term Evolution (LTE) or other suitable protocols. The wireless communications protocol may also include short-range communications devices and protocols, such as RFID, or Near-Field Communication radio transmissions. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

Specifically, the system 200 may comprise a BPS server 202 which is in communication with one or more local and/or remote data sources (204a, 204b). The BPS server 202 may be implemented as part of an enterprise application server that is accessible by a number of client computers (206, 208). The BPS server 202 hosts the bond pricing related functions, supports the client interfaces, and provides access to the data sources. For example, the BPS server 202 may receive client data from a central database and keep receiving updates of that database. The BPS server 202 may also receive bond pricing reference data from Bloomberg via a nightly file feed or from one or more other sources. Furthermore, market data may be retrieved or fed from internal or external credit traders, for example, through an interface to a database that credit traders use to trade corporate bonds. The client computers 206 and 208 may each be a networked workstation that can securely communicate with the BPS server 202.

In operation, the users may use the client computers 206 and 208 to authenticate themselves to the BPS server 202 before being granted appropriate access to the bond pricing functions and data. The BPS server 202 may mediate the client access and respond with the proper user interface screens and data.

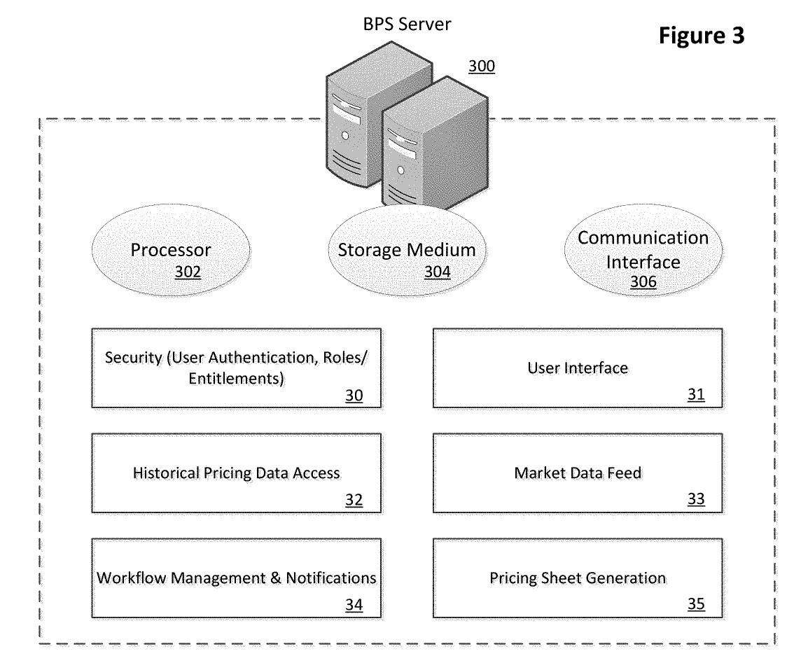

FIG. 3 is a block diagram illustrating an exemplary BPS server 300 according to one embodiment of the invention. In terms of hardware, the BPS server 300 may comprise a processor 302, a storage medium 304, and a communication interface 306. In terms of software, the BPS server 300 may include or run a number of functional modules such as Security 30, User Interface 31, Historical Pricing Data Access 32, Market Data Feed 33, Workflow Management & Notifications 34, and Pricing Sheet Generation 35. Although these functions are shown here as discrete modules, those skilled in the art may appreciate that at least some of these functions may be merged together or further divided into finer modules without substantively changing the intended effects.

Apart from the above-described first set of embodiments, further improvements and variations of the present invention may be implemented in a second set of embodiments as described hereinafter.

For example, the above-described bond pricing systems and methods may be expanded to other investment products such as high yield bonds (usually private placement, not traded on public markets), municipal bonds, sovereign bonds, individual debts, high yield equity, common stocks, commercial papers, or even currency, carbon credits, ethanol credits, bitcoins, etc. The pricing of these other investment products may require different market reference or comparable data specific to those investment types and may follow different procedures as compared to the bond pricing process described above.

For bond issuance, at least some syndicate functions could be implemented as part of the BPS, including but not limited to pricing research and analytical models. The user interface may be implemented as a web portal not limited to the DCM or syndicate users. Rather, the improved BPS may facilitate access by and communications with investors, issuers, and/or even regulators. The improved BPS may identify and evaluate market demand for particular bonds or bond types, for example, based on data from other banking branches and/or portal interactions with potential investors. The demand information may be conveyed to potential issuers via the BPS portal. Potential issuers may also use the BPS to browse bond data and filter potential or existing bond offerings by ratings, industry sectors, etc., whereby an issuer may target specific bond categories. The BPS portal may also perform match-making between issuers, underwriters, and investors.

The bond issue is priced in the BPS based on various factors such as term/tenor, maturity date, par or face value, coupon rate, current market interest rates, frequency of coupon payments, company ratings or creditworthiness, etc. The underwriter may evaluate demand by providing the proposed bond issuance to institutional buyers. That information affects bond pricing. The bond pricing logic may have a feedback loop that routes post-issuance market pricing data back into the pricing algorithm.

Preferably, the improved BPS includes or is compatible with a software application that can be used in a client's presence so as to vary terms (e.g., coupon rate) to see the effect on pricing. In another embodiment, the improved BPS is accessible by a downloadable software application (e.g., mobile app) that runs on an iPad or other mobile devices in the field by bank personnel or by clients.

The improved BPS may further facilitate and enhance cross-currency pricing capabilities, for example, by interfacing with foreign currency exchange databases and/or trading platforms to calculate pricing based on various data such as yield curves in a particular currency and exchange rates.

These and other improvements and advantages of the second set of embodiments may be appreciated by those skilled in the art from the description below.

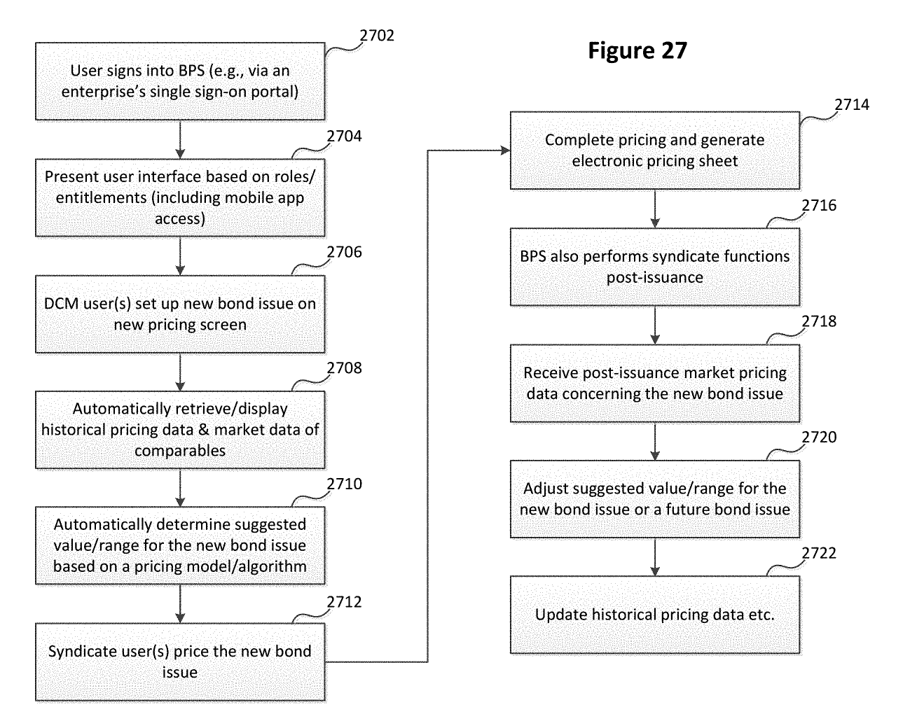

FIG. 27 is a flowchart illustrating another exemplary method for bond pricing according to another embodiment of the invention.

In Step 2702, a user may sign into the BPS via an authentication interface. The authentication may reply on the conventional username and password entries or it may use biometrics such as fingerprint scans or voice recognition. Other than a work station such as a desktop or laptop computer, the user may use a mobile computing device such as a smart phone or tablet computer to log onto the BPS.

In Step 2704, upon the user logging in, the BPS may present a user interface based on the user's role and/or entitlements. The interface may not only distinguish between a DCM user from a Syndicate user (or other user types) but also preferably distinguish the user devices. For example, the interface may be more streamlined and less graphically intense when the detected user device is a mobile computing device as opposed to a work station.

In Step 2706, the DCM user may set up a new bond issue as described above in connection with Step 106 in FIG. 1. Alternatively, as mentioned above, the new issue could be other securities other corporate bonds, such as municipal bonds, high yield equity and commercial papers.

In Step 2708, historical pricing data and market comparables data may be automatically retrieved and displayed by the BPS based on the new bond issue. Depending on which client issuer, bond type, and maturity are chosen by the user, the BPS may identify same or similar bonds previously or currently issued by the same issuer or issuers of comparable size and in the same industry sector, for example. The BPS may then communicate with the relevant data sources, local or remote, to retrieve the historical pricing data and market comparables data related to the identified bonds.

In Step 2710, before or during the performance of Step 2712 (i.e., Syndicate pricing step), the BPS may automatically determine suggested values and/or ranges for the new bond issue based on one or more pricing models or algorithms. Any well-known or proprietary model or algorithm may be employed to determine theoretically the most suitable values or ranges for the pricing parameters such as spread and yield, for example, in light of the issuer's credit ratings, benchmark rates, historical pricings, and secondary comparables etc. That is, other than simply using any previous pricing data as the default starting point for the new pricing, the BPS may more proactive calculate and recommend pricing levels. This may take place either before or during the Syndicate pricing step (2712).

In Step 2712, the Syndicate user may price the new bond issue set up by the DCM user. There may already be suggested values for the pricing parameters as calculated in Step 2710. Alternatively, as the Syndicate user tinkers with the pricing parameters, the BPS may automatically sense the user's attempts and present alternative suggestions in response. According to one embodiment, the BPS may flag key factors as support for its recommended pricing levels and/or for consideration by the user.

Next, in Step 2714, the DCM user may complete the pricing. The BPS may generate an electronic pricing sheet and other relevant information related to the new bond issue such as selected historical pricing and market comparables data. A pricing package may be prepared for delivery to the client issuer. According to another embodiment, the pricing sheet and related information about the issuer and comparables may also be packaged for distribution to potential bond buyers such as institutional investors. The distribution to investors may take place before issuer's approval of the pricing to collect market feedback on pricing and demand. Alternatively, the new bond issue information including issuer-approved pricing data may be sent to potential investors as part of a pre-issuance campaign (e.g., a roadshow).

In Step 2716, the BPS may also perform various syndicate functions on the new bond issue.

In Step 2718, the BPS may receive a feedback of post-issuance market pricing data and other data concerning the new bond issue. The market data may be retrieved from any suitable source or from the bond trading platform through which the Syndicate sells the new bond. According to one embodiment, the BPS or a related system may track the ownership of a bond after issuance, for example, once it is traded on the secondary market. Such ownership information may provide valuable insight into the demand for the issue bond and other bonds of similar type and/or pricing parameters and may inform on a decision to target specific buyers (e.g., investment funds, college endowments) for future issuance of bonds. Alternatively or additional, the BPS may receive feedback data about the bond issuer, such as any default or ratings change after a bond is issued, which may provide informative data concerning the issuer's risk profile.

In Step 2720, the market feedback may be analyzed and used to adjust suggested pricing values or ranges for the new bond issue (e.g., if any follow-on issuance is planned) or other future bond issues. The feedback data may also be used to update various types of information, such as intelligence on market demand, potential bond buyers, and issuer risk profile.

In Step 2722, the historical pricing data etc. may be updated based on the new bond pricing and market feedback.

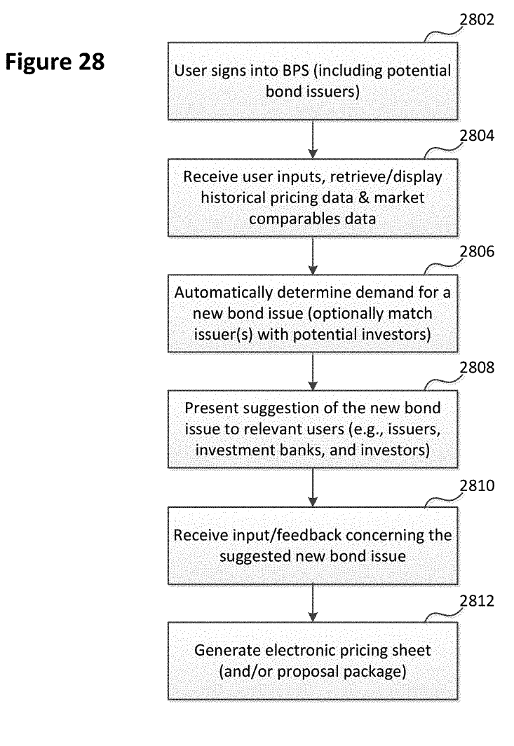

FIG. 28 is a flowchart illustrating yet another exemplary method for bond pricing according to another embodiment of the invention.

In Step 2802, various types of users may sign into the BPS including potential bond issuers and investors. The BPS may be offered as a web portal which can be securely accessed by essentially all parties relevant to a new bond issue, including both the bookrunner, Syndicate members, issuers, and investors. These different users will have different roles and entitlements on the BPS platform.

In Step 2804, the BPS may receive user inputs and retrieve and/or display historical pricing data and market comparables data. The types of interaction with the BPS will depend on the roles and entitlements of the authorized user are. For DCM and Syndicate users, they may be able to perform the pricing steps as described earlier. For an issuer or a would-be issuer (collectively, “issuer users”), the BPS may allow searching and browsing of historical pricing data and market comparables data which may be related to the issuer's own contemplated bond issue. The BPS may also allow issuer users to identify their needs for raising capital and guide them to drill down through a number of bond issuance options such as bond type, rate type, and maturity etc. Similarly, for investor users, the BPS may allow them to identify their interest in existing or potential bond issues and guide them to select bonds or bond categories that might meet their investment demand. The interactions with the issuer users and/or investor users may take the form of quick, interactive surveys or questionnaires.

In Step 2806, based on data received from various data sources and/or from various users, the BPS may automatically determine the demand for a new bond issue. For example, the BPS may pool the information on the supply side and the demand side, in connection with historical data and/or market data, to identify the potential areas of needs. The BPS may further determine and calculate tentative or suggested pricing parameters for the new bond issue. Optionally, the BPS may also match potential issuers with potential investors, thereby enhancing the likelihood of a successful underwriting.

In Step 2808, a suggestion of the new bond issue may be presented to relevant users such as issuers, investment banks, and investors. How much information is actually presented to each of these users may depend on authorization and ethical rules etc. Within those bounds, the BPS may facilitate the sharing of information with and promote communications among the bond community to achieve win-win solutions for interested parties. For example, for an issuer user, the BPS may present a pricing package for a suggested bond issue including information on market demand. For a potential bond buyer such an institutional investor, the BPS may present information of potential bond issues with contemplated pricing details but without revealing the issuers' information. For investment bank users, the BPS may generate a list of business leads for both the supply side and the demand side and suggest potential “match-making” targets.

In Step 2810, the BPS may receive inputs or feedback from one or more of the various users concerning the suggested new bond issue(s). The BPS may use such information to adjust or fine-tune the pricing details of the suggested new bond issue(s). Alternatively or additionally, the investment bank users may participate in revising the bond issuance suggestions.

In Step 2812, electronic pricing sheets and/or proposal packages may be generated for delivery to parties such as potential issuers or potential investors.

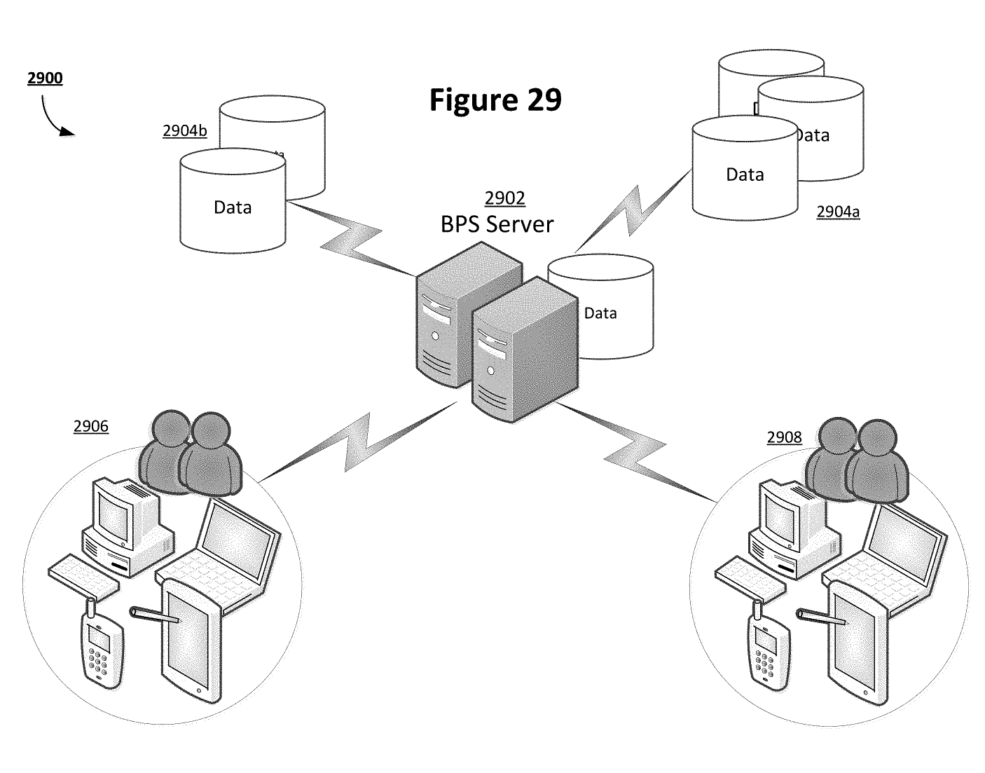

FIG. 29 is a block diagram illustrating an exemplary system 2900 for bond pricing according to another embodiment of the invention. The system 2900 may be different from the system 200 (FIG. 2) in the following aspects. The BPS server 2902 may accommodate the additional or alternative functionalities described above in connection with the second set of embodiments. The data sources or data stores (2904a, 2904b) may be more numerous and include more data to support pricing of security types other than corporate bond and to facilitate interactions with more user types. The client computers (2906, 2908) may include more device types including mobile computing devices such as smart phones and tablet computers. Accordingly, the BPS server 2902 and/or client computers (2906, 2908) may be programmed with improved software applications to implement the additional or alternative functionalities.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described herein can be made without departing from the spirit and scope of the invention. Accordingly, such modifications are considered within the scope of the invention as intended to be encompassed by the following claims and their legal equivalents.

1. A computer-implemented method for security pricing, the method comprising:
authenticating, via a secure portal in a computer or server system, at least one user to determine said at least one user's assigned role in a security pricing workflow, said at least one user comprising two or more persons each having responsibilities associated with setting pricing of a security prior to its issuance;
displaying an interactive user interface to said at least one user based on said at least one user's assigned role in the security pricing workflow to thereby control said workflow and promote collaboration among said two or more persons, the displaying comprising:
presenting a first interactive screen to a first user based on a first assigned role, said first user being a person and the first interactive screen receiving, from said first user, first input data in connection with setup of a new security issue and retrieval of historical security pricing and secondary market comparables data related to the new security issue, the new security issue being selected from a group consisting of: high yield bonds, municipal bonds, individual debts, syndicate loans, commercial papers, and stocks, and
presenting a second interactive screen to a second user based on a second assigned role, said second user being another person and the second interactive screen receiving, from said second user, second input data of pricing parameters for the new security issue which has been set up by the first user via the first interactive screen and automated calculation of additional pricing parameters based on the user input;
communicating with one or more data sources to receive the historical security pricing and secondary market comparables data subsequent to the setup of the new security issue by, or in response to a retrieval request from, the first user via the first interactive screen;
receiving, from an authorized one of said at least one user participating in the security pricing workflow, a request to complete the security pricing workflow;
preparing pricing data, by at least one processor and in response to the received request, based on at least some of the pricing parameters inputted by the second user via the second interactive screen, the additional pricing parameters calculated based on the user input of the second user, the received historical security pricing and secondary market comparables data; and
generating, in a predetermined electronic format according to one or more templates, a pricing sheet comprising said pricing data based on at least some of the pricing parameters, the additional pricing parameters, the historical security pricing and secondary market comparables data.

2. The computer-implemented method of claim 1, further comprising:
displaying a status screen to the at least one user based on said at least one user's role in the security pricing workflow.

3. The computer-implemented method of claim 1, further comprising:
presenting at least one notification to said at least one user to prompt a user action concerning the security pricing workflow.

4. The computer-implemented method of claim 3, wherein the at least one notification indicates an urgency or priority of the user action concerning the security pricing workflow.

5. The computer-implemented method of claim 4, wherein the urgency or priority of the user action is indicated by a color, style, or icon associated with a notification panel displayed in the user interface.

6. The computer-implemented method of claim 1, further comprising:
displaying the user interface on a web portal accessible by a web browser.

7. The computer-implemented method of claim 1, wherein the predetermined electronic format is selected from a group consisting of: a PowerPoint format, an Excel format, a PDF format, an HTML format, and an XML format.

8. The computer-implemented method of claim 1, wherein the generated pricing sheet is editable.

9. The computer-implemented method of claim 1, wherein the secondary market comparables data are received substantially in real time.

10. The computer-implemented method of claim 1, wherein the secondary market comparables data comprise credit default swap (CDS) pricing data related to an issuer of the new security issue or issuers of securities comparable to the new security issue.

11. The computer-implemented method of claim 1, further comprising:
displaying and facilitating an option of pricing the new security issue across two or more currencies.

12. The computer-implemented method of claim 1, further comprising:
determining at least one suggested value or range of the pricing parameters for the new security issue based at least in part on the historical security pricing and secondary market comparables data, thereby assisting the user input of the pricing parameters.

13. The computer-implemented method of claim 12, further comprising:
receiving a post-issuance feedback of market pricing for the new security issue; and
adjusting the at least one suggested value or range of the pricing parameters for the new security issue or for a future security issue based at least in part on the post-issuance feedback.

14. The computer-implemented method of claim 1, wherein the displaying further comprises:
presenting at least one third interactive screen to a third user, the third interactive screen facilitating performance of syndicate functions related to the new security issue.

15. The computer-implemented method of claim 1, wherein at least one of the first interactive screen and the second interactive screen is presented on a mobile computing device.

16. The computer-implemented method of claim 15, wherein the mobile computing device is selected from a group consisting of tablet computers and smart phones.

17. A computer-implemented system for security pricing, the system comprising:
a computer processor;
at least one storage medium; and
at least one communication interface;
the computer processor being configured to perform the following:
authenticating, via a secure portal in a computer or server system, at least one user to determine said at least one user's assigned role in a security pricing workflow, said at least one user comprising two or more persons each having responsibilities associated with setting pricing of a security prior to its issuance;
displaying an interactive user interface to said at least one user based on said at least one user's assigned role in the security pricing workflow to thereby control said workflow and promote collaboration among said two or more persons, the displaying comprising:
presenting a first interactive screen to a first user based on a first assigned role, said first user being a person and the first interactive screen receiving, from said first user, first input data in connection with setup of a new security issue and retrieval of historical security pricing and secondary market comparables data related to the new security issue, the new security issue being selected from a group consisting of: high yield bonds, municipal bonds, individual debts, syndicate loans, commercial papers, and stocks, and
presenting a second interactive screen to a second user based on a second assigned role, said second user being another person and the second interactive screen receiving, from said second user, second input data of pricing parameters for the new security issue which has been set up by the first user via the first interactive screen and automated calculation of additional pricing parameters based on the user input;
communicating with one or more data sources to receive the historical security pricing and secondary market comparables data subsequent to the setup of the new security issue by, or in response to a retrieval request from, the first user via the first interactive screen;
receiving, from an authorized one of said at least one user participating in the security pricing workflow, a request to complete the security pricing workflow;
preparing pricing data, in response to the received request, based on at least some of the pricing parameters inputted by the second user via the second interactive screen, the additional pricing parameters calculated based on the user input of the second user, the received historical security pricing and secondary market comparables data; and
generating, in a predetermined electronic format according to one or more templates, a pricing sheet comprising said pricing data based on at least some of the pricing parameters, the additional pricing parameters, the historical security pricing and secondary market comparables data.

18. The computer-implemented system of claim 17, wherein the computer processor is further configured to:
display a status screen to the at least one user based on said at least one user's role in the security pricing workflow.

19. The computer-implemented system of claim 17, wherein the computer processor is further configured to:
present at least one notification to said at least one user to prompt a user action concerning the security pricing workflow.

20. The computer-implemented system of claim 19, wherein the at least one notification indicates an urgency or priority of the user action concerning the security pricing workflow.

21. The computer-implemented system of claim 21, wherein the urgency or priority of the user action is indicated by a color, style, or icon associated with a notification panel displayed in the user interface.

22. The computer-implemented system of claim 17, wherein the computer processor is further configured to:
display the user interface on a web portal accessible by a web browser.

23. The computer-implemented system of claim 17, wherein the predetermined electronic format is selected from a group consisting of: a PowerPoint format, an Excel format, a PDF format, an HTML format, and an XML format.

24. The computer-implemented system of claim 17, wherein the generated pricing sheet is editable.

25. The computer-implemented system of claim 17, wherein the secondary market comparables data are received substantially in real time.

26. The computer-implemented system of claim 17, wherein the secondary market comparables data comprise credit default swap (CDS) pricing data related to an issuer of the new security issue or issuers of securities comparable to the new security issue.

27. The computer-implemented system of claim 17, wherein the computer processor is further configured to:
display and facilitate an option of pricing the new security issue across two or more currencies.

28. The computer-implemented system of claim 17, wherein the computer processor is further configured to:
determine at least one suggested value or range of the pricing parameters for the new security issue based at least in part on the historical security pricing and secondary market comparables data, thereby assisting the user input of the pricing parameters.

29. The computer-implemented system of claim 28, wherein the computer processor is further configured to:
receive a post-issuance feedback of market pricing for the new security issue; and
adjust the at least one suggested value or range of the pricing parameters for the new security issue or for a future security issue based at least in part on the post-issuance feedback.

30. The computer-implemented system of claim 17, wherein the displaying further comprises:
presenting at least one third interactive screen to a third user, the third interactive screen facilitating performance of syndicate functions related to the new security issue.

31. The computer-implemented system of claim 17, wherein at least one of the first interactive screen and the second interactive screen is presented on a mobile computing device.

32. The computer-implemented system of claim 31, wherein the mobile computing device is selected from a group consisting of tablet computers and smart phones.

33. A non-transitory computer readable medium containing computer readable code for security pricing, the computer readable code being configured to cause at least one processor to perform the following:
authenticating, via a secure portal in a computer or server system, at least one user to determine said at least one user's assigned role in a security pricing workflow, said at least one user comprising two or more persons each having responsibilities associated with setting pricing of a security prior to its issuance;
displaying an interactive user interface to said at least one user based on said at least one user's assigned role in the security pricing workflow to thereby control said workflow and promote collaboration among said two or more persons, the displaying comprising:
presenting a first interactive screen to a first user based on a first assigned role, said first user being a person and the first interactive screen receiving, from said first user, first input data in connection with setup of a new security issue and retrieval of historical security pricing and secondary market comparables data related to the new security issue, the new security issue being selected from a group consisting of: high yield bonds, municipal bonds, individual debts, syndicate loans, commercial papers, and stocks, and
presenting a second interactive screen to a second user based on a second assigned role, said second user being another person and the second interactive screen receiving, from said second user, second input data of pricing parameters for the new security issue which has been set up by the first user via the first interactive screen and automated calculation of additional pricing parameters based on the user input;
communicating with one or more data sources to receive the historical security pricing and secondary market comparables data subsequent to the setup of the new security issue by, or in response to a retrieval request from, the first user via the first interactive screen;
receiving, from an authorized one of said at least one user participating in the security pricing workflow, a request to complete the security pricing workflow;
preparing pricing data, in response to the received request, based on at least some of the pricing parameters inputted by the second user via the second interactive screen, the additional pricing parameters calculated based on the user input of the second user, the received historical security pricing and secondary market comparables data; and
generating, in a predetermined electronic format according to one or more templates, a pricing sheet comprising said pricing data based on at least some of the pricing parameters, the additional pricing parameters, the historical security pricing and secondary market comparables data.

34. A computer-implemented method for bond pricing, the method comprising:
communicating with one or more data sources to receive historical bond pricing and secondary market comparables data;
automatically determining a demand for a new bond issue based on the historical bond pricing and secondary market comparables data;
presenting the new bond issue with suggested pricing to at least one user selected from a group consisting of: bond issuers, investment banks, and investors;
receiving one or more inputs from the at least one user concerning the new bond issue with the suggested pricing; and
generating, in a predetermined electronic format, a pricing sheet comprising at least some of the suggested pricing, the historical bond pricing and secondary market comparables data.
